(19) United States
(12) Patent Application Publication
(10) Pub. No.: US 2025/0262662 A1
(43) Pub. Date: Aug. 21, 2025

(54) SOFT MAGNETIC ALLOY POWDER, MAGNETIC CORE, MAGNETIC COMPONENT, AND ELECTRONIC DEVICE

(71) Applicant: TDK CORPORATION, Tokyo (JP)

(72) Inventors: Masakazu HOSONO, Tokyo (JP); Kazuhiro YOSHIDOME, Tokyo (JP); Akito HASEGAWA, Tokyo (JP); Yoshiki KAJIURA, Tokyo (JP)

(73) Assignee: TDK CORPORATION, Tokyo (JP)

(21) Appl. No.: 19/067,197

(22) Filed: Feb. 28, 2025

Related U.S. Application Data
(63) Continuation-in-part of application No. 18/458,597, filed on Aug. 30, 2023, now abandoned.

(30) Foreign Application Priority Data
Aug. 31, 2022 (JP) 2022-138395

(51) Int. Cl. B22F 1/052; B22F 1/065; H01F 1/153; H01F 3/08

(52) U.S. Cl. CPC B22F 1/052; B22F 1/065; H01F 1/15308; H01F 1/15333; H01F 3/08; B22F 2301/35

(57) ABSTRACT

A soft magnetic alloy powder comprises first particles to fifth particles, each having a particle size within a specific range. Among the first particles to the fifth particles, nth particles have an average particle size xₙ (μm), an average circularity yₙ, and a variance zₙ of circularity, where nth is any ordinal number from first to fifth. Points (xₙ, yₙ) (n=1 to 5) plotted in an xy plane define an approximate straight line having a slope “my” of −0.0030 or more. Points (xₙ, zₙ) (n=1 to 5) plotted in an xz plane define an approximate straight line having a slope “mz” of 0.00050 or less.

### TECHNICAL FIELD

The present invention relates to a soft magnetic alloy powder, a magnetic core, a magnetic component, and an electronic device.

### BACKGROUND

Patent Document 1 discloses a toroidal core including an amorphous soft magnetic powder. The amorphous soft magnetic powder includes metal glass and has an average Wadell's working sphericity of 0.90 or more.
Patent Document 1: JP Patent Application Laid Open No. 2011-023673

### SUMMARY

It is an object of an exemplary embodiment of the present invention to provide a soft magnetic alloy powder with which a magnetic core having improved DC superimposition characteristics can be produced and a magnetic core or the like having improved DC superimposition characteristics.

To achieve the above object, a soft magnetic alloy powder of an exemplary embodiment of the present invention is a soft magnetic alloy powder comprising:
first particles including soft magnetic alloy particles having a particle size of D50 or less;
second particles including soft magnetic alloy particles having a particle size of more than D50 and D60 or less;
third particles including soft magnetic alloy particles having a particle size of more than D60 and D70 or less;
fourth particles including soft magnetic alloy particles having a particle size of more than D70 and D80 or less; and
fifth particles including soft magnetic alloy particles having a particle size of more than D80 and D90 or less,
wherein
nth particles among the first particles to the fifth particles have an average particle size xₙ (μm), an average circularity yₙ, and a variance zₙ of circularity, where nth is any ordinal number from first to fifth;
points (xₙ, yₙ) (n=1 to 5) plotted in an xy plane define an approximate straight line having a slope “my” of −0.0030 or more; and
points (xₙ, zₙ) (n=1 to 5) plotted in an xz plane define an approximate straight line having a slope “mz” of 0.00050 or less.

To achieve the above object, a magnetic core of the exemplary embodiment of the present invention is a magnetic core comprising:
first particles including soft magnetic alloy particles having a particle size of D50 or less;
second particles including soft magnetic alloy particles having a particle size of more than D50 and D60 or less;
third particles including soft magnetic alloy particles having a particle size of more than D60 and D70 or less;
fourth particles including soft magnetic alloy particles having a particle size of more than D70 and D80 or less; and
fifth particles including soft magnetic alloy particles having a particle size of more than D80 and D90 or less,
wherein
nth particles among the first particles to the fifth particles have an average particle size Xₙ (μm), an average circularity Yₙ, and a variance Zₙ of circularity, where nth is any ordinal number from first to fifth;
points (Xₙ, Yₙ) (n=1 to 5) plotted in an XY plane define an approximate straight line having a slope “mY” of −0.0030 or more; and
points (Xₙ, Zₙ) (n=1 to 5) plotted in an XZ plane define an approximate straight line having a slope “mZ” of 0.00050 or less.

The magnetic core may further comprise a resin.

A magnetic component of the exemplary embodiment of the present invention comprises the above magnetic core.

An electronic device of the exemplary embodiment of the present invention comprises the above magnetic core.

### BRIEF DESCRIPTION OF THE DRAWING(S)

FIG. 1 is a plurality of projections of powder particles.

FIG. 2 is another plurality of projections of powder particles.

FIG. 3 is another plurality of projections of powder particles.

FIG. 4 is another plurality of projections of powder particles.

FIG. 5 is another plurality of projections of powder particles.

FIG. 6 is another plurality of projections of powder particles.

FIG. 7 is an example chart generated in an X-ray crystal structure analysis.

FIG. 8 is a plurality of example patterns obtained by profile fitting of the chart of FIG. 7.

FIG. 9 is a schematic sectional view of a magnetic core.

FIG. 10 is a schematic sectional view of another magnetic core.

FIG. 11A is a schematic sectional view of an elliptical water flow atomizing apparatus according to an exemplary embodiment of the present invention.

FIG. 11B is a schematic view of a flow of a cooling liquid in the elliptical water flow atomizing apparatus illustrated in FIG. 11A viewed from a vertical direction.

FIG. 12A is a schematic view of a flow of a cooling liquid in a conventional atomizing apparatus viewed from a side.

FIG. 12B is a schematic view of the flow of the cooling liquid illustrated in FIG. 12A viewed from the vertical direction.

FIG. 13 is a plurality of example of an xy plane.

FIG. 14 is a plurality of example of an xz plane.

FIG. 15 is a plurality of example of an XY plane.

FIG. 16 is a plurality of example of an XZ plane.

### DETAILED DESCRIPTION

Hereinafter, a soft magnetic alloy powder and a magnetic core according to an embodiment of the present invention will be described.

The soft magnetic alloy powder according to the present embodiment includes powder particles. When the powder particles included in the soft magnetic alloy powder are classified into multiple types of powder particles by particle size, all types of powder particles have approximately the same average circularity and approximately the same variance of circularity.

Specifically, the soft magnetic alloy powder according to the present embodiment is a soft magnetic alloy powder including first particles, second particles, third particles, fourth particles, and fifth particles. The first particles include soft magnetic alloy particles having a particle size of D50 or less. The second particles include soft magnetic alloy particles having a particle size of more than D50 and D60 or less. The third particles include soft magnetic alloy particles having a particle size of more than D60 and D70 or less. The fourth particles include soft magnetic alloy particles having a particle size of more than D70 and D80 or less. The fifth particles include soft magnetic alloy particles having a particle size of more than D80 and D90 or less.

Among the first particles to the fifth particles, nth particles have an average particle size xₙ (μm), an average circularity yₙ, and a variance zₙ of circularity, where nth is any ordinal number from first to fifth. Points (xₙ, yₙ) (n=1 to 5) plotted in an xy plane define an approximate straight line having a slope “my” of −0.0030 or more. Points (xₙ, zₙ) (n=1 to 5) plotted in an xz plane define an approximate straight line having a slope “mz” of 0.00050 or less.

The slope “my” is preferably −0.0020 or more. The slope “my” does not have an upper limit. The upper limit is, for example, 0.0000 or less.

The slope “mz” is preferably 0.00030 or less. The slope “mz” does not have a lower limit. The lower limit is, for example, 0.00005 or more.

The particle size of each powder particle is the projected area diameter thereof. Hereinafter, the projected area diameter may simply be referred to as the equivalent circle diameter. The projected area diameter may also be referred to as the Heywood diameter.

Circularity is represented by 2×(πS)^{1/2}/L, where S is the area of the powder particle in its projection and L is the circumference of the powder particle. Circularity may be referred to as Wadell's circularity.

The variance of circularity is an average squared deviation from the mean of circularity.

D50 of the soft magnetic alloy powder is the corresponding particle size at a number-based cumulative relative frequency of 50% in the particle size distribution of the soft magnetic alloy powder. D60 of the soft magnetic alloy powder is the corresponding particle size at a number-based cumulative relative frequency of 60%. D70 of the soft magnetic alloy powder is the corresponding particle size at a number-based cumulative relative frequency of 70%. D80 of the soft magnetic alloy powder is the corresponding particle size at a number-based cumulative relative frequency of 80%. D90 of the soft magnetic alloy powder is the corresponding particle size at a number-based cumulative relative frequency of 90%.

In other words, the first particles are powder particles at a number-based cumulative relative frequency of 50% or less in the particle size distribution of the soft magnetic alloy powder. The second particles are powder particles at a number-based cumulative relative frequency of above 50% and 60% or less in the particle size distribution of the soft magnetic alloy powder. The third particles are powder particles at a number-based cumulative relative frequency of above 60% and 70% or less in the particle size distribution of the soft magnetic alloy powder. The fourth particles are powder particles at a number-based cumulative relative frequency of above 70% and 80% or less in the particle size distribution of the soft magnetic alloy powder. The fifth particles are powder particles at a number-based cumulative relative frequency of above 80% and 90% or less in the particle size distribution of the soft magnetic alloy powder.

An approximate straight line is drawn by linear approximation using a method of least squares of points plotted in a coordinate plane. Specifically, the slope of a straight line defined with an approximation formula obtained by linear approximation, i.e., the slope of a linear regression line, is calculated. The linear regression line on the xy plane indicates dependency of the circularity on particle size. The linear regression line on the xz plane indicates dependency of the variance of circularity on particle size.

The powder particles included in the soft magnetic alloy powder may have any overall average particle size D1. From the viewpoint of readily obtaining the soft magnetic alloy powder having the above structure, D1 may be 1.0 μm or more and 25.0 μm or less or may be 5.0 μm or more and 15.0 μm or less.

The powder particles included in the soft magnetic alloy powder may have any overall average circularity C1. From the viewpoint of readily improving DC superimposition characteristics of a magnetic core to be obtained in the end, C1 may be 0.90 or more or may be 0.95 or more.

Hereinafter, a method of identifying the first to fifth particles in the soft magnetic alloy powder and a method of calculating the average circularity of each type of particles and the variance of circularity thereof will be described.

Any method of identifying the first to fifth particles in the soft magnetic alloy powder may be used. First, the particle size distribution of the soft magnetic alloy powder is measured. Any method of measuring the particle size distribution may be used. Various particle size analyses (e.g., a laser diffraction method) can be used for measurement. In particular, a particle image analyzer Morphologi G3 (Malvern Panalytical) may be used. Morphologi G3 is an analyzer that enables the powder to be dispersed using air, individual particle shapes to be projected, and resulting projections to be evaluated.

Specifically, from the projected areas of the individual particles, the equivalent circle diameters (particle sizes) of the individual particles can be obtained. In the present embodiment, equivalent circle diameters mean Heywood diameters. From the equivalent circle diameters of the individual particles, the particle size distribution can be obtained. According to the particle size distribution, the corresponding particle size at a number-based cumulative relative frequency of 50% can be D50; the corresponding particle size at a number-based cumulative relative frequency of 60% can be D60; the corresponding particle size at a number-based cumulative relative frequency of 70% can be D70; the corresponding particle size at a number-based cumulative relative frequency of 80% can be D80; and the corresponding particle size at a number-based cumulative relative frequency of 90% can be D90. In the present embodiment, the particle size distribution is measured using the equivalent circle diameters of at least 2,000 particles or preferably 20,000 particles or more.

The soft magnetic alloy powder according to the present embodiment may have the D50 of 0.6 μm or more and 23.5 μm or less, the D60 of 0.8 μm or more and 27.5 μm or less, the D70 of 1.0 μm or more and 32.5 μm or less, the D80 of 1.3 μm or more and 37.5 μm or less, and the D90 of 1.8 μm or more and 50.0 μm or less.

With the projections of the individual particles and the particle size distribution, the first to fifth particles are identified. The slope “my” of the approximate straight line defined by the points (xₙ, yₙ) (n=1 to 5) plotted in the xy plane and the slope “mz” of the approximate straight line defined by the points (xₙ, zₙ) (n=1 to 5) plotted in the xz plane can be calculated, where xₙ (μm) is the average particle size of the nth particles among the first to fifth particles, yₙ is the average circularity of the nth particles among the first to fifth particles, and zₙ is the variance of circularity of the nth particles among the first to fifth particles.

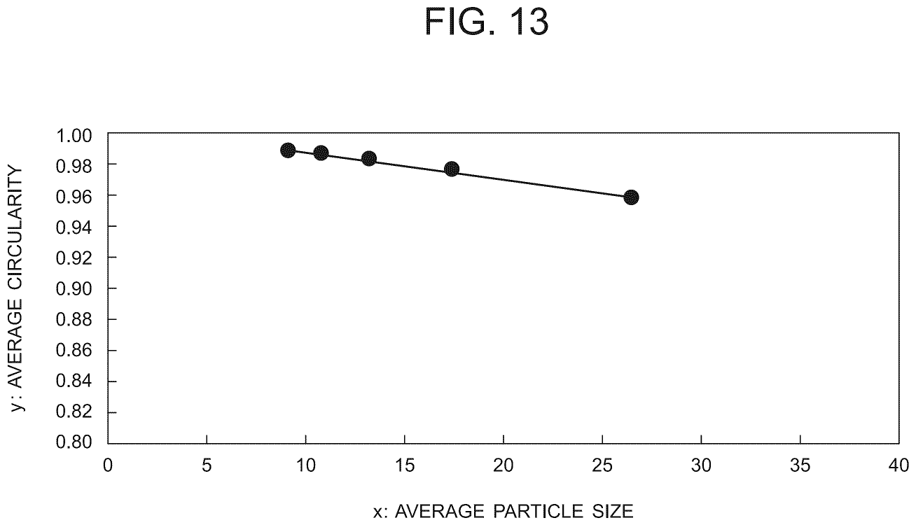

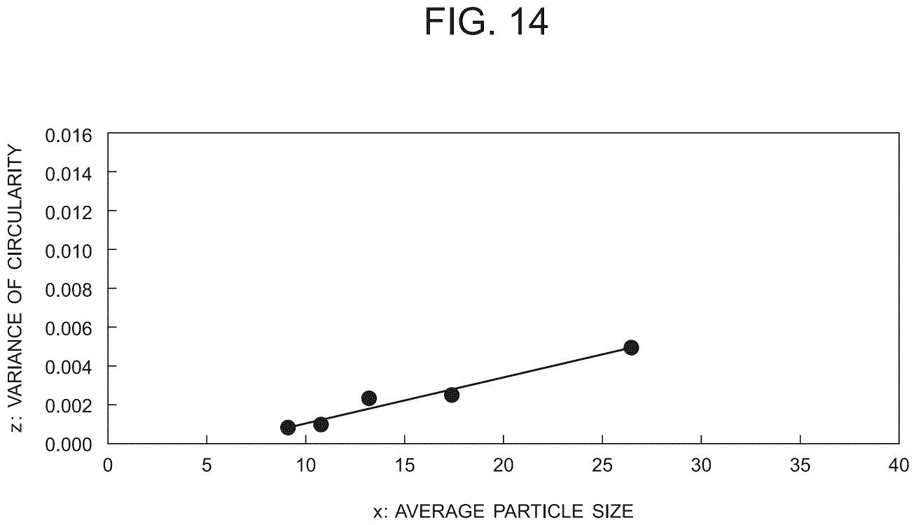

FIG. 13 is a plurality of example of above xy plane. FIG. 14 is a plurality of example of above xz plane. The slope of the approximate straight line described in FIG. 13 is “my”, and the slope of the approximate straight line described in FIG. 14 is “mz”

Because Morphologi G3 can generate projections of multiple particles at one time for evaluation, shapes of the multiple particles can be evaluated in a short amount of time. Thus, Morphologi G3 is suitable for evaluating the particle size distribution and the like of the soft magnetic alloy powder prior to molding. It is possible to generate the projections of the multiple particles, automatically calculate the particle sizes and circularities of the individual particles, and calculate the above parameters.

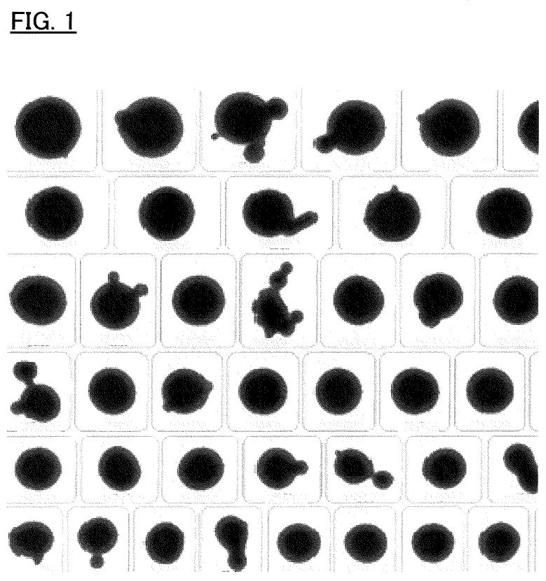

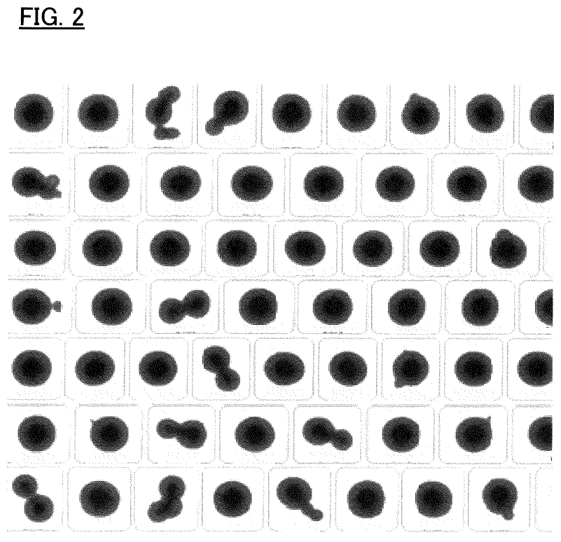

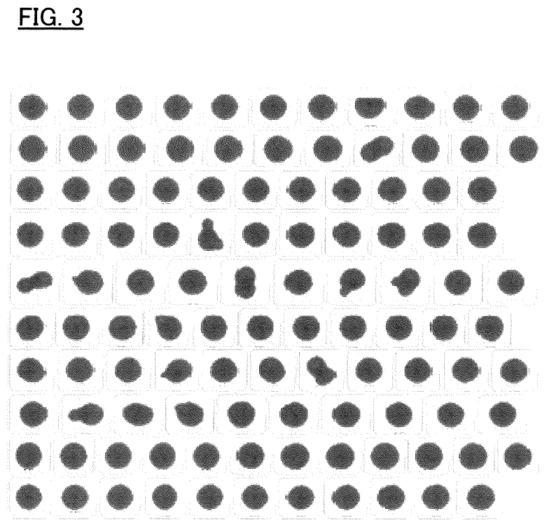

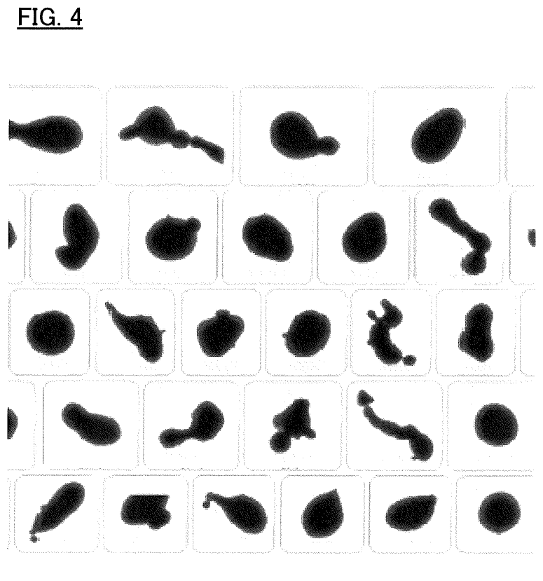

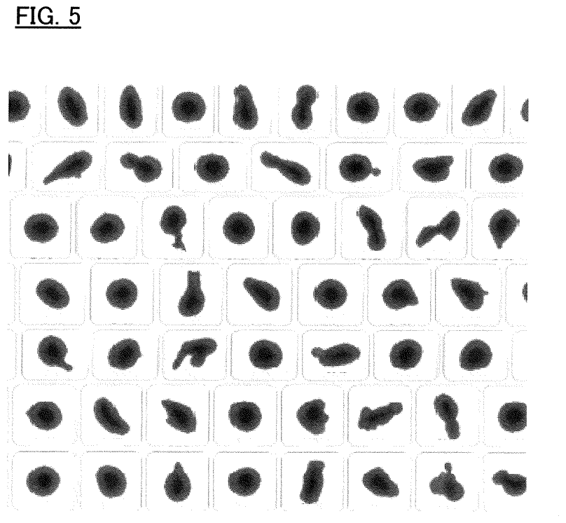

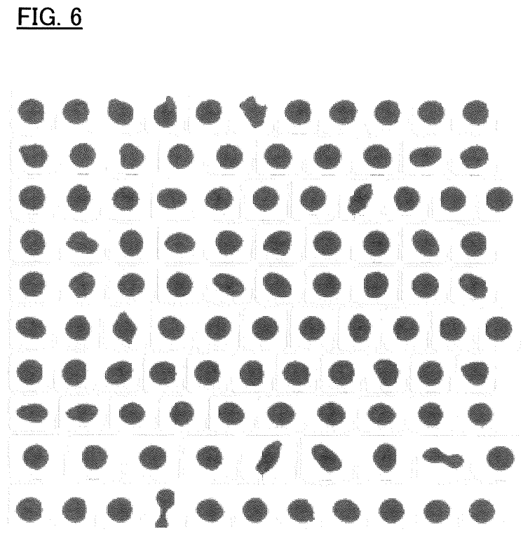

FIGS. 1 to 3 are projections of particles per particle size of Sample No. 7, which is an example described later. FIGS. 4 to 6 are projections of particles per particle size of Sample No. 1, which is a comparative example described later. In comparison between FIGS. 1 to 3 and FIGS. 4 to 6, the variance of circularity of the soft magnetic alloy powder illustrated in FIGS. 1 to 3 is less dependent on particle size than the variance of circularity of the soft magnetic alloy powder illustrated in FIGS. 4 to 6 is.

When a conventional atomizing apparatus is used, it is difficult to produce the soft magnetic alloy powder according to the present embodiment. When a specific atomizing apparatus described later is used and manufacturing conditions are appropriately controlled, it is possible to produce the soft magnetic alloy powder according to the present embodiment.

The soft magnetic alloy powder according to the present embodiment may have any composition. For example, the soft magnetic alloy powder may have an alloy composition that tends to have a crystalline structure, such as an Fe—Si based, Fe—Co—Si based, Fe—Co—Si—Cr based, Fe—Ni based, Fe—Ni—Mo based, Fe—Si—Cr based, Fe—Si—Al based, Fe—Si—Al—Ni based, or Fe—Ni—Si—Co based alloy composition.

From the viewpoint of reducing coercivity of the soft magnetic alloy powder and reducing coercivity of a magnetic core produced using the soft magnetic alloy powder, the soft magnetic alloy powder may have an alloy composition that tends to have an Fe based amorphous structure or an alloy composition that tends to have an Fe based nanocrystalline structure. Examples of the alloy compositions that tend to have an Fe based amorphous structure or the alloy compositions that tend to have an Fe based nanocrystalline structure include Fe—Nb—B—P—S based, Fe—Co—Nb—B—P—S based, Fe—Nb—B—Si—Cu based, Fe—Nb—B based, Fe—Si—B based, Fe—Si—Cr—B—C based, Fe—Co—Si—Cr—B—P based, Fe—Co—Si—Cr—B—P—C based, and Fe—Si—B—C based alloy compositions.

The soft magnetic alloy powder according to the present embodiment may have any microstructure. The soft magnetic alloy powder may have an amorphous structure, a nanocrystalline structure, or a crystalline structure.

An amorphous structure refers to a structure having an amorphous ratio X of 85% or more. Amorphous structures include a structure in which crystals are contained to the extent that the amorphous ratio reaches 85% or more. Amorphous structures include an approximately amorphous structure r a hetero-amorphous structure. A hetero-amorphous structure refers to a structure in which crystals are present in an amorphous solid. When the soft magnetic alloy powder has a hetero-amorphous structure, the average crystal size of crystals in the amorphous solid may be 0.1 nm or more and 10 nm or less. A nanocrystalline structure refers to a structure having an amorphous ratio X of less than 85% and an average crystal size of 100 nm or less. The average crystal size of the crystals in the nanocrystalline structure may be 3 nm or more and 50 nm or less. A crystalline structure refers to a structure having an amorphous ratio X of less than 85% and an average crystal size exceeding 100 nm.

The amorphous ratio X can be measured by an X-ray crystal structure analysis using XRD or may be measured by electron backscattered diffraction (EBSD) or electron diffraction. Hereinafter, a method of measuring the amorphous ratio by an X-ray crystal structure analysis using XRD will be described.

The amorphous ratio X of the soft magnetic alloy powder is represented by Formula 1 shown below.

$$X = 100 - ( Ic / ( Ic + Ia ) \times 100 ) \qquad Formula 1$$

Ic: Crystal scattering integrated intensity
Ia: Amorphous scattering integrated intensity

The amorphous ratio X is calculated as follows. An X-ray crystal structure analysis of the soft magnetic alloy powder using XRD is performed. In the analysis, phases are identified, and peaks (Ic: crystal scattering integrated intensity, Ia: amorphous scattering integrated intensity) of crystallized Fe or a crystallized compound are read. From the intensities of these peaks, the crystallization ratio is determined, and the amorphous ratio X is calculated using the above Formula 1. Hereinafter, the calculation method will be described more specifically.

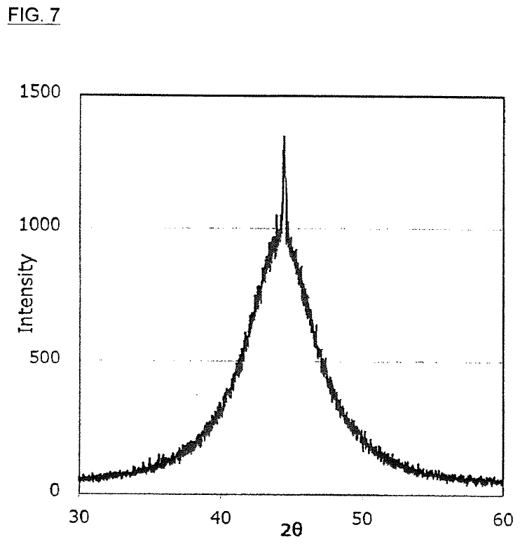

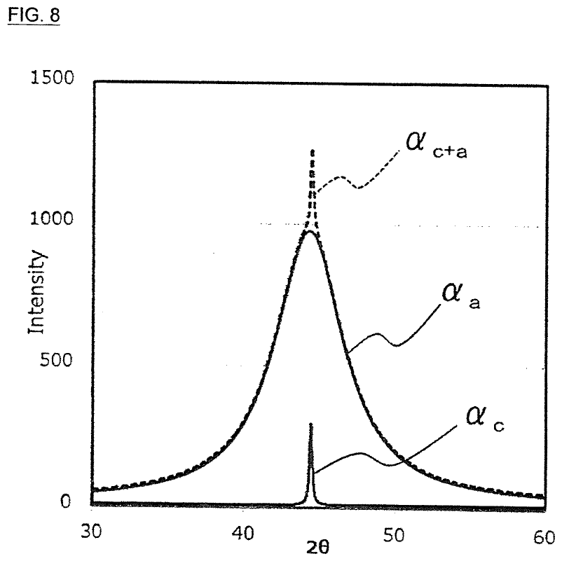

The X-ray crystal structure analysis of the soft magnetic alloy powder using XRD is performed to generate a chart like the one shown as FIG. 7. Then, profile fitting is performed to this chart using a Lorentzian function shown as Formula 2 below to generate a crystal component pattern α_{c} showing the crystal scattering integrated intensity, an amorphous component pattern αₐ showing the amorphous scattering integrated intensity, and a pattern α_{c+a} showing a combination of these patterns, as shown in FIG. 8. From the patterns of the crystal scattering integrated intensity and the amorphous scattering integrated intensity, the amorphous ratio X is calculated using the above Formula 1. Note that the range of measurement is within a diffraction angle of 2θ=30° to 60° in which a halo derived from amorphousness can be confirmed. The difference between the actual integrated intensities measured using XRD and the integrated intensities calculated using the Lorentzian function is 1% or less in this range.

$$f ( x ) = \frac{h}{1 + \frac{{( x - u )}^{2}}{{w}^{2}}} + b \qquad Formula 2$$

h: Peak height
u: Peak position
w: Half width
b: Background height

Producing a magnetic core using the soft magnetic alloy powder according to the present embodiment can improve the DC superimposition characteristics of the magnetic core.

A magnetic core according to the present embodiment includes the above powder particles. When the powder particles included in the magnetic core are classified into multiple types of particles by particle size observed in a cross section of the magnetic core, all types of particles have approximately the same average circularity and approximately the same variance of circularity.

Specifically, the magnetic core according to the present embodiment is a magnetic core produced using the soft magnetic alloy powder including the first particles including the soft magnetic alloy particles having a particle size of D50 or less, the second particles including the soft magnetic alloy particles having a particle size of more than D50 and D60 or less, the third particles including the soft magnetic alloy particles having a particle size of more than D60 and D70 or less, the fourth particles including the soft magnetic alloy particles having a particle size of more than D70 and D80 or less, and the fifth particles including the soft magnetic alloy particles having a particle size of more than D80 and D90 or less.

In the cross section of the magnetic core according to the present embodiment, the soft magnetic alloy particles may have the D50 of 0.5 μm or more and 19.0 μm or less, the D60 of 0.6 μm or more and 22.0 μm or less, the D70 of 0.8 μm or more and 26.0 μm or less, the D80 of 1.0 μm or more and 30.0 μm or less, and the D90 of 1.4 μm or more and 40.0 μm or less.

Among the first particles to the fifth particles, nth particles included in the magnetic core have an average particle size Xₙ (μm), an average circularity Yₙ, and a variance Zₙ of circularity, where nth is any ordinal number from first to fifth. Points (Xₙ, Yₙ) (n=1 to 5) plotted in an XY plane define an approximate straight line having a slope “mY” of −0.0030 or more. Points (Xₙ, Zₙ) (n=1 to 5) plotted in an XZ plane define an approximate straight line having a slope “mZ” of 0.00050 or less.

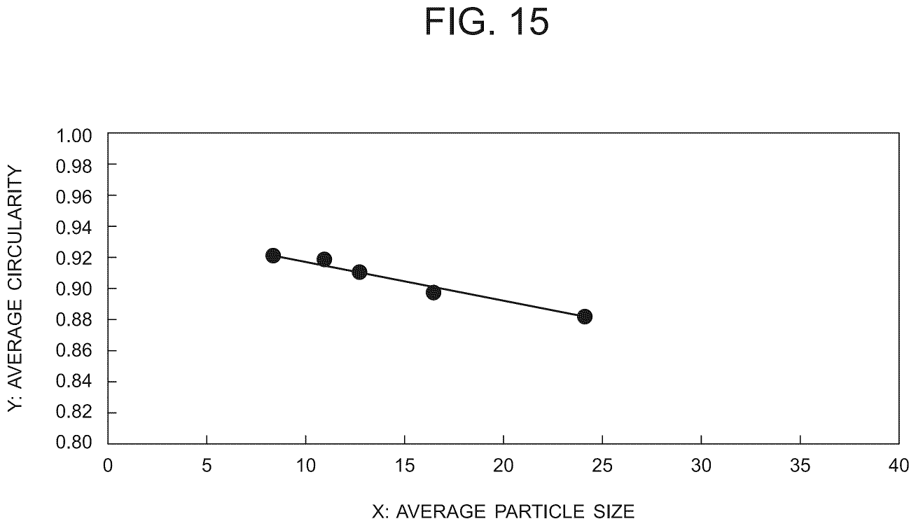

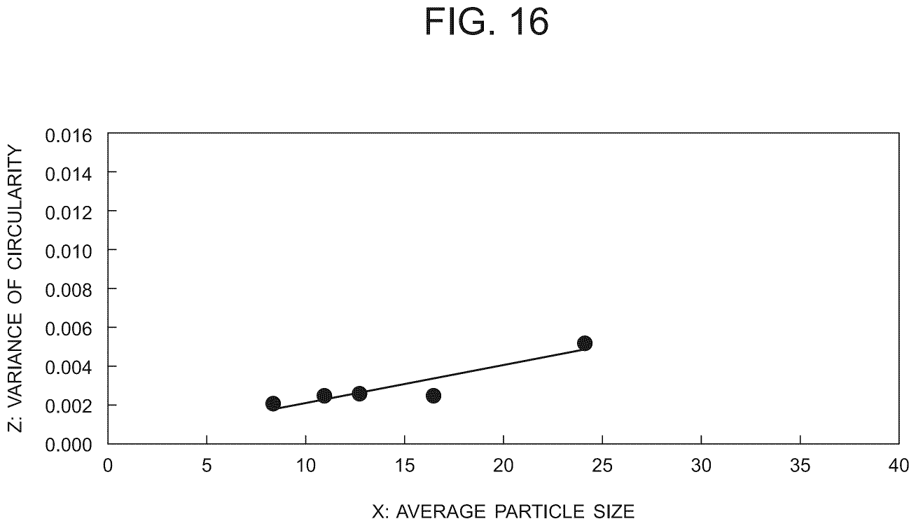

FIG. 15 is a plurality of example of above XY plane. FIG. 16 is a plurality of example of above XZ plane. The slope of the approximate straight line described in FIG. 15 is “mY”, and the slope of the approximate straight line described in FIG. 16 is “mZ”

The slope “mY” is preferably −0.0020 or more. The slope “mY” does not have an upper limit. The upper limit is, for example, 0.0000 or less.

The slope “mZ” is preferably 0.00030 or less. The slope “mZ” does not have a lower limit. The lower limit is, for example, 0.00005 or more.

The linear regression line on the XY plane indicates dependency of the circularity on particle size. The linear regression line on the XZ plane indicates dependency of the variance of circularity on particle size.

The particles included in the cross section of the magnetic core may have any overall average particle size D2. From the viewpoint of readily obtaining the magnetic core having the above structure, D2 may be 1.0 μm or more and 25.0 μm or less or may be 5.0 μm or more and 15.0 μm or less.

The particles included in the cross section of the magnetic core may have any overall average circularity C2. From the viewpoint of readily improving the DC superimposition characteristics of the magnetic core having the above structure, C2 may be 0.70 or more, 0.75 or more, or 0.85 or more.

The magnetic core may include a resin in addition to the above soft magnetic alloy particles. The resin may be of any type, and the amount of the resin is not limited. Examples of the resin include thermosetting resins, such as a phenol resin and an epoxy resin. The amount of the resin may be 1 mass % or more and 5 mass % or less with respect to soft magnetic alloy.

The magnetic core according to the present embodiment may include fine particles, non-magnetic particles, other soft magnetic alloy particles distinguishable from the above soft magnetic alloy particles, etc. provided that the DC superimposition characteristics are suitably maintained. The amount of the other soft magnetic alloy particles, fine particles, and non-magnetic particles is not limited and is, for example, 30 wt % or less with respect to the entire magnetic core. The magnetic core may also include modifiers, preservatives, dispersants, etc.

Next, a method of identifying the first to fifth particles in the soft magnetic alloy particles included in the magnetic core and a method of calculating the average circularity of each type of particles and the variance of circularity thereof will be described.

First, any part of the magnetic core is cut off to give a cross section of the magnetic core. The cross section is then observed. Any method of observing the cross section may be used. For example, an electron microscope (e.g., a SEM, a STEM, and a TEM) may be used. The field of view and magnification are not limited as long as individual sectional shapes of at least 2,000 soft magnetic alloy particles are observed.

Then, the equivalent circle diameters of the individual particles included in the field of view are calculated. Any method of calculating the equivalent circle diameters may be used. For example, an analysis program may be used. However, when the analysis program or the like is used, portions that are apparently not particles may be recognized as particles. Such portions are appropriately left out in the calculation.

From the equivalent circle diameters of the individual particles, particle size distribution can be obtained. According to the particle size distribution, the corresponding particle size at a number-based cumulative relative frequency of 50% can be D50; the corresponding particle size at a number-based cumulative relative frequency of 60% can be D60; the corresponding particle size at a number-based cumulative relative frequency of 70% can be D70; the corresponding particle size at a number-based cumulative relative frequency of 80% can be D80; and the corresponding particle size at a number-based cumulative relative frequency of 90% can be D90. In the present embodiment, the particle size distribution is measured using the equivalent circle diameters of at least 2,000 particles.

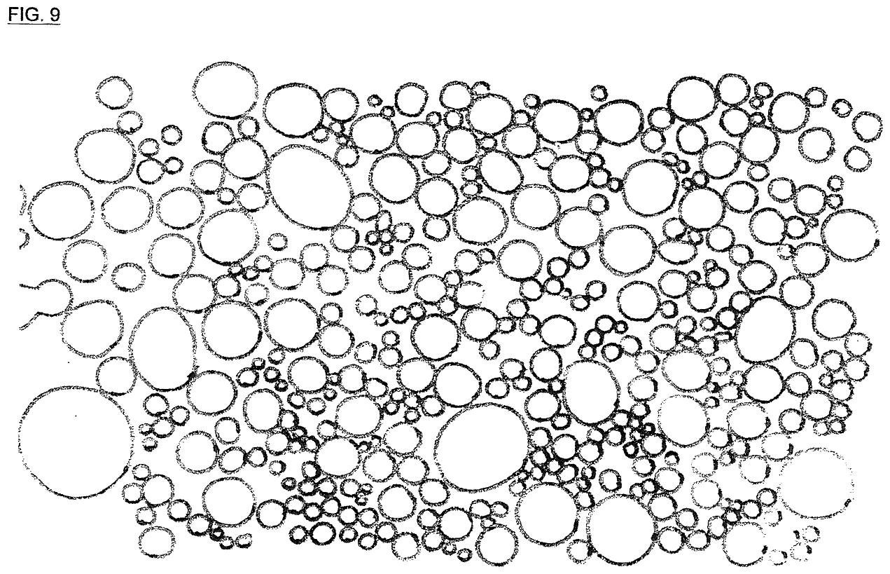

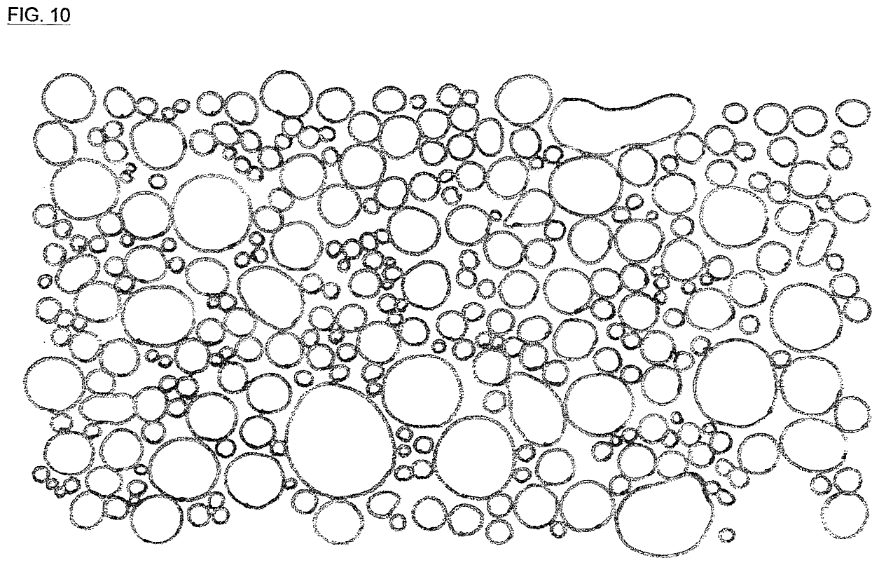

FIG. 9 is a schematic sectional view of the magnetic core according to the present embodiment. FIG. 10 is a schematic sectional view of a conventional magnetic core. The variance of circularity of the soft magnetic alloy particles of the magnetic core illustrated in FIG. 9 is less dependent on particle size than the variance of circularity of the soft magnetic alloy particles of the magnetic core illustrated in FIG. 10 is.

The number-based particle size distribution and the circularity of the soft magnetic alloy powder confirmed with Morphologi G3 and the number-based particle size distribution and the circularity of the soft magnetic alloy particles in the cross section of the magnetic core obtained in the end do not correspond.

However, the number-based particle size distribution and the circularity of the magnetic powder confirmed with Morphologi G3 and the number-based particle size distribution and the circularity of the particles in the magnetic powder in the cross section of the magnetic core obtained in the end are correlated. Thus, confirmation of the particle size distribution and the circularity of the soft magnetic alloy powder with Morphologi G3 enables, to some degree, estimation of the particle size distribution of the soft magnetic alloy particles in the cross section of the magnetic core obtained in the end. That is, the number-based particle size distribution and the circularity of the soft magnetic alloy particles in the cross section of the magnetic core obtained in the end are easily controlled by control of the number-based particle size distribution and the circularity of the soft magnetic alloy powder prior to molding.

When produced by press molding the soft magnetic alloy powder according to the present embodiment, a magnetic core tends to be the magnetic core according to the present embodiment. Provided that relative permeability (μ) is the same due to different molding pressures between the magnetic core according to the present embodiment and the conventional magnetic core, the former magnetic core has higher DC superimposition characteristics. The relative permeability (μ) of the magnetic core is not limited.

The packing density of the soft magnetic alloy particles in the magnetic core can be controlled by control of manufacturing conditions (e.g., molding pressure), resin ratio, etc. The packing density may be, for example, 70 vol % to 90 vol %.

In measurement of the circularity per particle size of soft magnetic alloy particles included in a magnetic core produced by press molding the soft magnetic alloy powder, the larger the particle size of the soft magnetic alloy particles, the smaller tends to be the average circularity, and the larger tends to be the variance of circularity. That is, the circularity and the variance of circularity tend to be highly dependent on particle size. When the soft magnetic alloy particles having a particularly large size and a particularly distorted shape are included in the magnetic core, local saturation is readily generated around there. Consequently, in particular, the DC superimposition characteristics are readily reduced.

It has been conventionally difficult to reduce both dependency of the circularity on particle size and dependency of the variance of circularity on particle size. However, the present inventors have found that use of the atomizing apparatus described later enables manufacture of the soft magnetic alloy particles having low dependency of the circularity on particle size and low dependency of the variance of circularity on particle size. The present inventors have also found that the magnetic core produced using the soft magnetic alloy powder has low dependency of the circularity on particle size, low dependency of the variance of circularity on particle size, and improved DC superimposition characteristics.

Hereinafter, a method of manufacturing the soft magnetic alloy powder according to the present embodiment will be described.

Any method of manufacturing the soft magnetic alloy powder may be used. However, the present inventors have found that, when a soft magnetic alloy powder is produced by a gas atomization method using an elliptical water flow atomizing apparatus 10 described later, the soft magnetic alloy powder readily has low dependency of the circularity on particle size and low dependency of the variance of circularity on particle size.

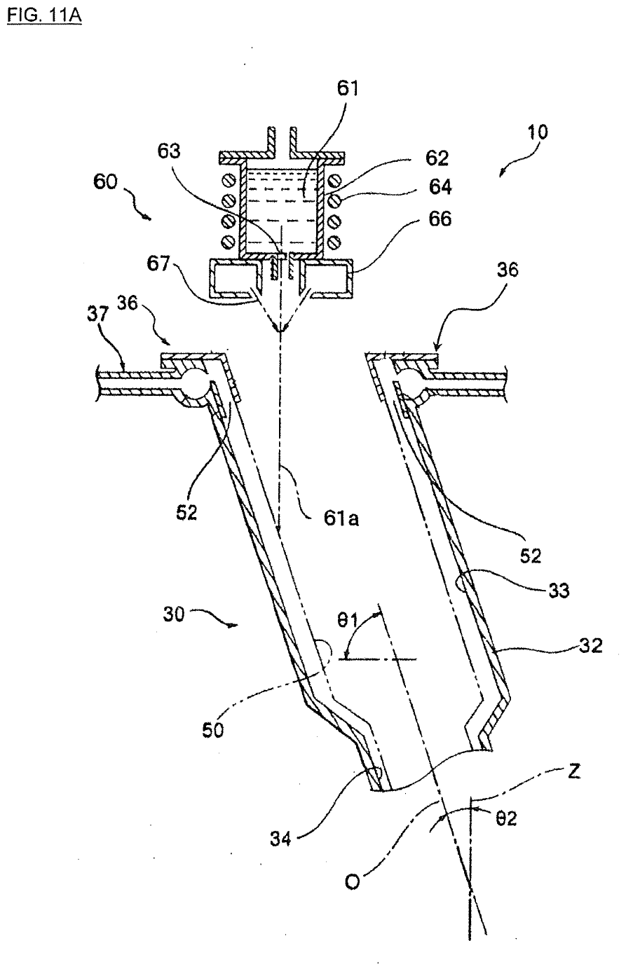

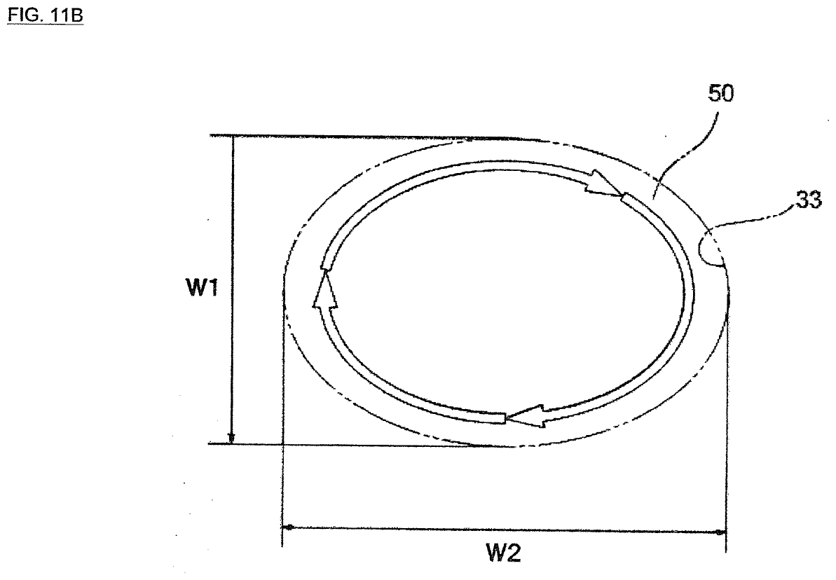

Hereinafter, one example of a method of manufacturing the soft magnetic alloy powder will be described. The soft magnetic alloy powder may be manufactured by the gas atomization method. Specifically, the elliptical water flow atomizing apparatus 10 illustrated in FIG. 11A may be used for manufacture. The elliptical water flow atomizing apparatus 10 is an apparatus in which a cooling water flow in an elliptical spiral can be generated. Use of the elliptical water flow atomizing apparatus 10 enables manufacture of the soft magnetic alloy powder under optimum rapid cooling conditions.

As illustrated in FIG. 11A, the elliptical water flow atomizing apparatus 10 includes a molten metal supply unit 60 and a cooling unit 30 disposed below the supply unit in the vertical direction. In FIG. 11A, the vertical direction is the Z-axis direction. The molten metal supply unit 60 includes a heat resistant container 62 for containing a molten metal 61. A heating coil 64 is disposed around the outer circumference of the container 62. At the time of manufacture of the soft magnetic alloy powder, a mother alloy having a desired alloy composition is put inside the container 62 and is melted using the heating coil 64 to give the molten metal 61, which is maintained at a predetermined range of temperature.

Any method of manufacturing the mother alloy may be used. For example, raw materials (e.g., pure metals) of the constituent elements of the soft magnetic alloy powder may be weighed to satisfy the intended alloy composition and be melted by high-frequency heating in a chamber having a predetermined degree of vacuum to give the mother alloy. The temperature of the molten metal 61, which is given by melting the mother alloy, is not limited. The temperature of the molten metal 61 is determined based on the melting point of the alloy having the intended alloy composition. For example, the temperature can be 1200° C. to 1600° C.

A molten metal discharge port 63 is provided at the bottom of the container 62. The molten metal 61 maintained at the predetermined temperature is discharged as a molten metal drip 61a from the molten metal discharge port 63 towards an inner circumferential surface 33 of a tubular body 32 constituting the cooling unit 30.

Gas spray nozzles 66 are disposed at an outer portion of an outer bottom wall of the container 62 so as to surround the molten metal discharge port 63. Each gas spray nozzle 66 is provided with a gas spray port 67. From the gas spray ports 67, a high-pressure gas is sprayed on the molten metal drip 61a. More specifically, the high-pressure gas is sprayed diagonally downwards from the entire circumference of the molten metal 61 discharged from the molten metal discharge port 63. Thus, the molten metal drip 61a turns into multiple liquid drops and drips onto the inner circumferential surface 33 of an upper inside portion of the tubular body 32 along the gas flow.

The high-pressure gas may be an inert gas (e.g., a nitrogen gas, an argon gas, and a helium gas) or a reducing gas (e.g., an ammonia decomposition gas).

In order to obtain the soft magnetic alloy powder according to the present embodiment, the ratio of the volume (Gv) of the atomizing gas (high-pressure gas) to the gas pressure (Gp) of the atomizing gas (high-pressure gas) is adjusted. Suitable values of Gv/Gp may change depending on the composition of the mother alloy or the like. For example, Gv/Gp may be 0.5 m³/MPa or more and 30 m³/MPa or less.

Control of the amount of the molten metal 61 discharged can control the average particle size D1 of the soft magnetic alloy powder. The smaller the amount of metal discharge, the smaller tends to be the average particle size D1. The larger the amount of metal discharge, the larger tends to be the average particle size D1. The average particle size D1 can also be controlled by adjusting factors such as the gas spraying pressure, the distance that the molten metal drip 61a travels to reach the cooling unit 30, and the water flow rate of the cooling unit 30, in addition to the amount of metal discharge.

The cooling unit 30 includes the tubular body 32 having the inner circumferential surface 33, a cooling liquid introduction unit 36 provided at an upper portion of the tubular body 32, and a discharge port 34 provided at a lower portion of the tubular body 32. The tubular body 32 is placed with its axis O inclined at a predetermined angle θ2 relative to the vertical direction (Z-axis direction). The upper portion of the tubular body 32 having its axis O inclined at the predetermined angle θ2 is horizontally cut off perpendicular to the Z-axis direction, and the top of the tubular body 32 is open in an elliptical shape. Moreover, the shape of a cross section, inclined at an angle θ1 relative to the axis O, of the inner circumferential surface 33 of the tubular body 32 has an elliptical shape as illustrated in FIG. 11B. Such elliptical cross sections are continuously provided along the axis O.

θ1 is represented by θ1=(90 degrees−θ2). The elliptical cross sections are horizontal cross sections, which are perpendicular to the vertical direction, of the inner circumferential surface 33 (tubular body 32). The direction of the major axis of the elliptical shape of a horizontal cross section of the inner circumferential surface 33 may correspond to the direction in which the axis O of the tubular body 32 is inclined relative to the Z-axis (vertical line). That is, the tubular body 32 may be structured so that the major axis of the horizontal cross section is included in a plane containing the axis O of the tubular body 32 and the Z-axis intersecting the axis O.

As illustrated in FIG. 11B, the elliptical shape of the horizontal cross section of the inner circumferential surface 33 has a short diameter W1 and a long diameter W2. To obtain the soft magnetic alloy powder according to the present embodiment, the ratio (W2/W1) of the long diameter W2 to the short diameter W1 is adjusted. Suitable values of W2/W1 may change depending on the composition of the mother alloy or the like. For example, W2/W1 may be 1.04 or more and 3.00 or less.

The cooling liquid introduction unit 36 of the cooling unit 30 includes a supply line 37 and a cooling liquid discharge port 52. In the cooling liquid introduction unit 36, the cooling liquid supplied from the supply line 37 is discharged from the cooling liquid discharge port 52 along the inner circumferential surface 33 of the tubular body 32. The cooling liquid introduction unit 36 has an optimum structure for generating an elliptical spiral water flow. The cooling liquid discharged from the cooling liquid discharge port 52 flows in a downward direction of the axis O in an elliptical spiral along the inner circumferential surface 33. The cooling liquid discharged from the cooling liquid discharge port 52 forms a cooling liquid layer 50 having a constant thickness.

The molten metal drip 61a sprayed on the inner circumferential surface 33 by the high-pressure gas is rapidly cooled by the cooling liquid layer 50 including the elliptical spiral water flow. In the elliptical spiral water flow of the cooling liquid layer 50, the flow speed of the cooling liquid is faster at a short diameter side of the ellipse and slower at a long diameter side of the ellipse. Thus, the molten metal drip 61a sprayed on the cooling liquid layer 50 flows in the downward direction of the axis O at the changing flow speeds of the cooling liquid in the elliptical spiral water flow. The point onto which the molten metal drip 61a is sprayed may be a point having a minimum curvature of the ellipse.

Change of the speed of the molten metal drip 61a flowing in the cooling liquid layer 50 as described above makes it easier for a vapor film generated around the molten metal drip 61a to be peeled from the molten metal drip 61a. Thus, rapid cooling efficiency of the molten metal drip 61a improves. Solidification of the molten metal drip 61a in the elliptical spiral water flow of the cooling liquid layer 50 gives the soft magnetic alloy powder according to the present embodiment. The soft magnetic alloy powder is discharged from the discharge port 34 at the lower portion of the tubular body 32 together with the cooling liquid. The soft magnetic alloy powder taken out from the elliptical water flow atomizing apparatus 10 may be appropriately dried, classified, etc.

It is believed that W2/W1, Gv/Gp, and the like described above have influence on manufacture of the soft magnetic alloy powder according to the present embodiment. Suitable control of W2/W1 and Gv/Gp enables manufacture of the soft magnetic alloy powder according to the present embodiment. When W2/W1 is small or when Gv/Gp is large, the variance of circularity tends to be highly dependent on particle size. When W2/W1 is large or when Gv/Gp is small, the circularity tends to be highly dependent on particle size.

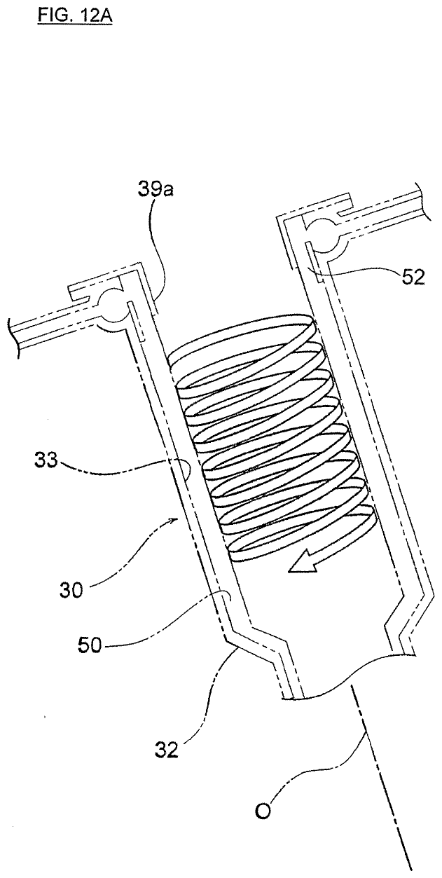

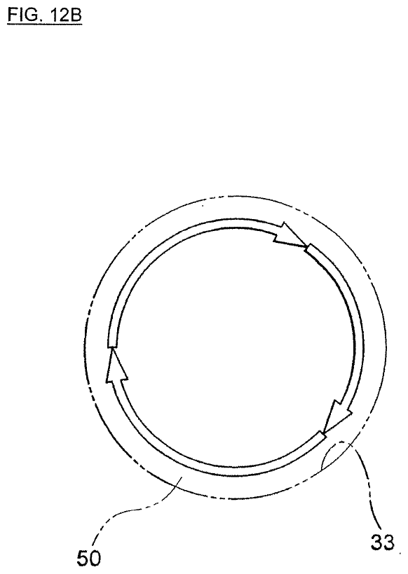

In contrast, as illustrated in FIGS. 12A and 12B, a cross section perpendicular to the axis O of the inner circumferential surface 33 of the tubular body 32 of the conventional atomizing apparatus is circular (W2/W1=1.00). The cooling liquid discharge port 52 thereof is also circular.

The particle size of the soft magnetic alloy powder may be adjusted by dry classification, wet classification, etc. Examples of dry classification methods include dry sieving and air flow classification. Examples of wet classification methods include wet filtration classification using a filter and classification by centrifuging.

The soft magnetic alloy powder according to the present embodiment may include an insulation film. To provide the insulation film on the surfaces of the soft magnetic alloy particles included in the soft magnetic alloy powder, the soft magnetic alloy powder may be subjected to a film formation treatment (e.g., heat treatment, phosphate treatment, mechanical alloying, silane coupling treatment, and hydrothermal synthesis).

The soft magnetic alloy powder according to the present embodiment may be used for any purpose. The soft magnetic alloy powder can be applied to various magnetic components. In particular, the soft magnetic alloy powder can be suitably used as a material of a magnetic core included in magnetic components, such as inductors, transformers, and choke coils.

The magnetic core according to the present embodiment may be any type of magnetic core. Hereinafter, a dust core as the magnetic core will be described. That is, a method of producing the magnetic core by press molding will be described.

Any method of manufacturing the magnetic core may be used. For example, first, the soft magnetic alloy powder according to the present embodiment and a resin are kneaded to give a resin compound. The resin compound may be a granulated powder. At this time, a soft magnetic alloy powder produced using the conventional gas atomizing apparatus, a fine powder having a smaller average particle size than the soft magnetic alloy powder according the present embodiment, and/or a non-magnetic powder, etc. may be added to the resin compound. Modifiers, preservatives, dispersants, etc. may also be added. A mold is then filled with the resin compound. Press molding is performed. Then, the resin is hardened to give the magnetic core.

Specifically, first, the soft magnetic alloy powder and the resin are mixed. Mixing the powder with the resin makes it easier to give a pressed body having high strength by molding. The resin may be any type of resin. Examples of the resin include a phenol resin and an epoxy resin. The amount of the resin is not limited. When the resin is added, 1 mass % or more and 5 mass % or less of the resin may be added with respect to the magnetic powder.

A mixture of the soft magnetic alloy powder and the resin is granulated to give a granulated powder. Any method of granulation may be used. For example, a stirrer may be used for granulation. The granulated powder may have any particle size.

The granulated powder is press molded to give the pressed body. The press molding pressure is not limited. For example, the pressure may be 0.1 t/cm² or more and 20 t/cm² or less. When the soft magnetic alloy powder produced with the elliptical water flow atomizing apparatus is used, the relative permeability (μ) can be increased with a relatively smaller press molding pressure, compared to when the conventional atomizing apparatus is used. Additionally, the DC superimposition characteristics of the magnetic core can be improved compared to when the conventional atomizing apparatus is used.

Hardening the resin included in the pressed body can give the magnetic core. Any hardening method may be used, and a heat treatment may be performed under conditions that enable hardening of the resin.

The magnetic core may be used for any purpose. For example, the magnetic core can be suitably used as a magnetic core for an inductor, particularly a power inductor. Moreover, the magnetic core can be suitably used for an inductor integrally including the magnetic core and a coil.

Further, the above magnetic core and a magnetic component including the above magnetic core can be suitably used for an electronic device.

In particular, because the above magnetic core readily has relatively high DC superimposition characteristics, the above magnetic core is suitably used in fields in need of smaller size, higher frequency, higher efficiency, and energy saving. For example, the above magnetic core can be suitably used as a magnetic core implemented in compact, high-speed switching power supply for smartphones and in-vehicle equipment and for a magnetic component and an electronic device.

### EXAMPLES

Hereinafter, the present invention will be specifically described with examples.

### Experiment 1

### <Soft Magnetic Alloy Powder>

Raw material metals were weighed so as to satisfy a soft magnetic alloy composition of 83.9Fe-12.2Nb-2.0B-1.8P-0.1S in weight ratio and melted by high-frequency heating to produce a mother alloy. Specifically, raw materials of pure metals such as Fe, Nb, and other subcomponents were prepared and weighed so that the above soft magnetic alloy composition could be satisfied after melting. The weighed raw materials of the pure metals were melted by high-frequency heating in a vacuumed chamber to give the mother alloy.

The mother alloy was heated and melted to give a metal in a molten state having a temperature of 1500° C. Then, a gas atomization method was used to produce a soft magnetic alloy powder having the alloy composition of samples. Specifically, when the molten mother alloy was discharged from a molten metal discharge port to a cooling part in a tubular body, a high-pressure gas was sprayed onto a discharged molten metal drip. The high-pressure gas was an N₂ gas. The molten metal drip collided with the cooling part (cooling water), cooled, and solidified to form the soft magnetic alloy powder.

For Sample No. 1 in which the tubular body at the cooling part had a W2/W1 ratio of 1.00, a conventional atomizing apparatus illustrated in FIGS. 12A and 12B was used. For other Sample numbers in which W2/W1>1.00 was satisfied, an elliptical water flow atomizing apparatus illustrated in FIGS. 11A and 11B was used.

As for gas atomizing conditions, the sprayed amount of the molten metal was 1 to 20 kg/min, and the cooling water pressure was 1 to 30 MPa. The above conditions were appropriately controlled so as to give the intended soft magnetic alloy powder. A parameter Gv/Gp obtained by dividing the volume (Gv) of the atomizing gas by the pressure (Gp) of the atomizing gas was as shown in Table 1. Gv was changed within a range of approximately 4 m³ to 16 m³, and Gp was changed within a range of approximately 0.5 MPa to 12 MPa.

Then, a heat treatment was performed for the given soft magnetic alloy powder, and nanocrystals having a crystal size of 30 nm or less were precipitated, to reduce the amorphous ratio X to 10%. Specifically, the heat treatment was performed at 400° C. to 650° C. for 10 to 60 minutes.

It was confirmed that, in each sample, the composition of the mother alloy and the composition of the powder were approximately the same by ICP analysis. An X-ray diffraction measurement was performed for each powder to measure the amorphous ratio X. When the amorphous ratio X was 85% or more, the powder was deemed to have an amorphous structure. When the amorphous ratio X was less than 85% and the average crystal size was 100 nm or less, the powder was deemed to have a nanocrystalline structure. When the amorphous ratio X was less than 85% and the average crystal size exceeded 100 nm, the powder was deemed to have a crystalline structure. It was confirmed that all powders of Experiment 1 had a nanocrystalline structure.

Next, the average particle size D1 and the average circularity C1 of each soft magnetic alloy powder were measured. First, individual particle projections were observed with Morphologi G3 (Malvern Panalytical). The shapes of 20,000 powder particles were observed at a magnification of 10×. Specifically, 3 cc (volume) of the powder was dispersed at an air pressure of 1 bar to 3 bars to take projections with a laser microscope. The projected area diameter of each powder particle in its projection was measured as the particle size. The particle sizes of the particle powders were averaged to calculate the average particle size D1 based on the number of particles.

Moreover, the circularity of each of the individual powder particles was measured using the projections of the particles. Then, the average circularity C1 of the powder particles was calculated based on the number of particles.

Further, the slopes “my” and “mz” were calculated using the size of each powder particle and the circularity of each powder particle.

The soft magnetic alloy powders in all examples described below had the D50 of 2.0 μm or more and 15.0 μm or less, the D60 of 3.0 μm or more and 17.5 μm or less, the D70 of 4.0 μm or more and 20.0 μm or less, the D80 of 6.0 μm or more and 25.0 μm or less, and the D90 of 8.0 μm or more and 35.0 μm or less.

### <Magnetic Core>

A toroidal core was produced using the soft magnetic alloy powder of each sample.

First, the soft magnetic alloy powder and an epoxy resin were kneaded to give a resin compound. The ratio at which the soft magnetic alloy powder and the epoxy resin were mixed was controlled so that the resin occupied 2.5 wt % of the toroidal core.

A mold was filled with the resin compound, and the resin compound was pressurized to give a toroidal pressed body. The molding pressure was controlled so that the toroidal core obtained in the end had a relative permeability (μ) of 30 (when a DC magnetic field was not being applied).

The toroidal pressed body was heated at 180° C. for 60 minutes for hardening the epoxy resin included in the pressed body to give the toroidal core. The toroidal core had an outer diameter of 11 mm, an inner diameter of 6.5 mm, and a thickness of 2.5 mm. As many number of toroidal cores as necessary for the tests described below were produced.

The average particle size D2 and the average circularity C2 of the soft magnetic alloy particles in a cross section of the toroidal core were measured. First, any part of the toroidal core was cut off. Then, a SEM image of the soft magnetic alloy particles in the resulting cross section of the toroidal core was observed at a magnification (100× to 1000×) at which the particles could be distinguished. The SEM image was analyzed to measure D2 and C2. Software used for the image analysis was Mac-View (manufactured by MOUNTECH Co., Ltd.). From the shape of each particle in the SEM image, the projected area diameter of each particle was measured as its particle size. The particle sizes of the particle powders were averaged to calculate the average particle size D2 based on the number of particles.

From the shape of each particle in the SEM image, the circularity of each particle was measured. Then, the average circularity C2 of the powder particles was calculated based on the number of particles.

Further, the slopes “mY” and “mZ” were calculated using the size of each particle and the circularity of each particle.

In the cross section of the magnetic core in all examples described below, the soft magnetic alloy particles had the D50 of 1.5 μm or more and 12.0 μm or less, the D60 of 2.0 μm or more and 14.0 μm or less, the D70 of 3.0 μm or more and 16.0 μm or less, the D80 of 4.5 μm or more and 20.0 μm or less, and the D90 of 6.0 μm or more and 30.0 μm or less.

The following method was used to confirm that the relative permeability (μ) of the toroidal core of each sample was 30. First, a polyurethane copper wire (UEW wire) was wound around the toroidal core. The inductance of the toroidal core was measured with an LCR meter (4284A manufactured by Agilent Technologies) at a frequency of 1 MHz without application of a direct current. Using the inductance, relative permeability (μ) was calculated. It was confirmed that relative permeability (μ) was 30.

A DC magnetic field of 8 kA/m was applied to the toroidal core of each sample to measure the inductance. Using the inductance, DC permeability (μHdc) was calculated. Relative to the DC permeability (μHdc) of the toroidal core produced with the conventional atomizing apparatus (the toroidal core of Sample No. 1 in Experiment 1), the increase rate of μHdc was calculated. When the increase rate of μHdc was 1.30 times or more, the DC superimposition characteristics were deemed good. When the increase rate of μHdc was 1.70 times or more, the DC superimposition characteristics were deemed better. When the increase rate of μHdc was 2.00 times or more, the DC superimposition characteristics were deemed best. Table 1 shows the test results.

TABLE 1

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (−) | (m³/MPa) | (μm) | (−) | (−) | (−) | (μm) | (−) | (−) | (−) | (−) |
| 1 | Comparative Example | 1.00 | 5 | 7.81 | 0.97 | −0.0014 | 0.00070 | 7.18 | 0.87 | −0.0015 | 0.00068 | 1.00 |
| 2 | Comparative Example | 1.03 | 5 | 7.88 | 0.96 | −0.0015 | 0.00062 | 7.25 | 0.86 | −0.0016 | 0.00065 | 1.02 |
| 3 | Example | 1.04 | 5 | 7.72 | 0.96 | −0.0014 | 0.00050 | 7.11 | 0.85 | −0.0014 | 0.00049 | 1.30 |
| 4 | Example | 1.05 | 5 | 7.81 | 0.96 | −0.0014 | 0.00042 | 7.14 | 0.85 | −0.0015 | 0.00040 | 1.45 |
| 5 | Example | 1.07 | 5 | 7.77 | 0.96 | −0.0013 | 0.00034 | 7.15 | 0.85 | −0.0013 | 0.00035 | 1.74 |
| 6 | Example | 1.10 | 5 | 7.96 | 0.96 | −0.0012 | 0.00025 | 7.34 | 0.85 | −0.0014 | 0.00028 | 2.53 |
| 7 | Example | 1.20 | 5 | 7.92 | 0.96 | −0.0014 | 0.00020 | 7.29 | 0.85 | −0.0015 | 0.00021 | 2.81 |
| 8 | Example | 1.30 | 5 | 7.81 | 0.96 | −0.0015 | 0.00016 | 7.25 | 0.85 | −0.0017 | 0.00019 | 2.73 |
| 9 | Example | 2.85 | 5 | 7.91 | 0.95 | −0.0024 | 0.00013 | 7.22 | 0.84 | −0.0024 | 0.00014 | 2.31 |
| 10 | Example | 3.00 | 5 | 7.88 | 0.94 | −0.0030 | 0.00011 | 7.26 | 0.83 | −0.0030 | 0.00012 | 2.13 |
| 11 | Comparative Example | 3.50 | 5 | 7.92 | 0.94 | −0.0032 | 0.00010 | 7.29 | 0.82 | −0.0034 | 0.00010 | 1.23 |
| 12 | Comparative Example | 1.20 | 0.4 | 7.84 | 0.91 | −0.0036 | 0.00010 | 7.22 | 0.80 | −0.0039 | 0.00011 | 1.14 |
| 13 | Example | 1.20 | 1 | 7.86 | 0.93 | −0.0028 | 0.00013 | 7.24 | 0.81 | −0.0029 | 0.00012 | 1.35 |
| 14 | Example | 1.20 | 2 | 7.90 | 0.94 | −0.0017 | 0.00016 | 7.28 | 0.83 | −0.0019 | 0.00017 | 2.11 |
| 7 | Example | 1.20 | 5 | 7.92 | 0.96 | −0.0014 | 0.00020 | 7.29 | 0.85 | −0.0015 | 0.00021 | 2.81 |
| 16 | Example | 1.20 | 15 | 8.20 | 0.97 | −0.0013 | 0.00029 | 7.75 | 0.85 | −0.0014 | 0.00030 | 2.21 |
| 17 | Example | 1.20 | 30 | 8.40 | 0.97 | −0.0012 | 0.00050 | 8.12 | 0.85 | −0.0012 | 0.00049 | 1.70 |
| 18 | Comparative Example | 1.20 | 32 | 8.40 | 0.97 | −0.0012 | 0.00057 | 8.18 | 0.85 | −0.0013 | 0.00070 | 1.28 |

According to Table 1, when W2/W1 was 1.04 or more and 3.00 or less and Gv/Gp was 1 m³/MPa or more and 30 m³/MPa or less, the slopes “my” and “mz” of the soft magnetic alloy powder were within predetermined ranges. The slopes “mY” and “mZ” of the magnetic core (toroidal core) produced using the soft magnetic alloy powder were within predetermined ranges, and the DC superimposition characteristics were good.

In contrast, when W2/W1 was too small and when Gv/Gp was too large, the absolute value of the slope “mz” of the soft magnetic alloy powder was too large. Moreover, the slope “mZ” of the magnetic core (toroidal core) produced using the soft magnetic alloy powder fell outside the predetermined range, and the DC superimposition characteristics were reduced.

When W2/W1 was too large and when Gv/Gp was too small, the absolute value of the slope “my” of the soft magnetic alloy powder was too large. Moreover, the slope “mY” of the magnetic core (toroidal core) produced using the soft magnetic alloy powder fell outside the predetermined range, and the DC superimposition characteristics were reduced.

### Experiment 2

Experiment 2 was conducted as in Experiment 1 except that the composition of the soft magnetic alloy powder was changed to 67.1Fe-16.8Co-12.2Nb-2.0B-1.8P-0.1S (Table 2), 83.4Fe-5.6Nb-2.0B-7.7Si-1.3Cu (Table 3), or 86.2Fe-12.0Nb-1.8B (Table 4) in weight ratio. It was confirmed that all powders of Experiment 2 had a nanocrystalline structure.

TABLE 2

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (−) | (m³/MPa) | (μm) | (−) | (−) | (−) | (μm) | (−) | (−) | (−) | (−) |
| 19 | Comparative Example | 1.00 | 5 | 7.91 | 0.97 | −0.0013 | 0.00068 | 7.28 | 0.86 | −0.0014 | 0.00066 | 1.00 |
| 20 | Comparative Example | 1.03 | 5 | 7.94 | 0.97 | −0.0014 | 0.00060 | 7.31 | 0.86 | −0.0015 | 0.00061 | 1.03 |
| 21 | Example | 1.04 | 5 | 7.88 | 0.96 | −0.0014 | 0.00048 | 7.26 | 0.85 | −0.0015 | 0.00039 | 1.28 |
| 22 | Example | 1.20 | 5 | 7.92 | 0.96 | −0.0015 | 0.00021 | 7.29 | 0.85 | −0.0016 | 0.00022 | 2.77 |
| 23 | Example | 3.00 | 5 | 7.90 | 0.95 | −0.0028 | 0.00014 | 7.28 | 0.85 | −0.0027 | 0.00013 | 2.12 |
| 24 | Comparative Example | 3.50 | 5 | 7.93 | 0.95 | −0.0031 | 0.00012 | 7.31 | 0.84 | −0.0031 | 0.00012 | 1.21 |
| 25 | Comparative Example | 1.20 | 0.4 | 7.87 | 0.93 | −0.0035 | 0.00011 | 7.25 | 0.84 | −0.0037 | 0.00011 | 1.18 |
| 26 | Example | 1.20 | 1.0 | 7.88 | 0.94 | −0.0026 | 0.00013 | 7.25 | 0.84 | −0.0028 | 0.00012 | 1.32 |
| 27 | Example | 1.20 | 2 | 7.90 | 0.95 | −0.0017 | 0.00016 | 7.26 | 0.85 | −0.0020 | 0.00017 | 1.99 |
| 22 | Example | 1.20 | 5 | 7.92 | 0.96 | −0.0015 | 0.00021 | 7.29 | 0.85 | −0.0016 | 0.00022 | 2.77 |
| 29 | Example | 1.20 | 15 | 7.99 | 0.96 | −0.0014 | 0.00030 | 7.32 | 0.86 | −0.0014 | 0.00027 | 2.15 |
| 30 | Example | 1.20 | 30 | 8.10 | 0.96 | −0.0013 | 0.00049 | 7.42 | 0.86 | −0.0014 | 0.00042 | 1.64 |
| 31 | Comparative Example | 1.20 | 32 | 8.24 | 0.97 | −0.0012 | 0.00056 | 7.59 | 0.86 | −0.0013 | 0.00067 | 1.12 |

TABLE 3

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (−) | (m³/MPa) | (μm) | (−) | (−) | (−) | (μm) | (−) | (−) | (−) | (−) |
| 32 | Comparative Example | 1.00 | 5 | 5.61 | 0.98 | −0.0013 | 0.00066 | 5.21 | 0.86 | −0.0014 | 0.00065 | 1.00 |
| 33 | Comparative Example | 1.03 | 5 | 5.59 | 0.98 | −0.0014 | 0.00054 | 5.19 | 0.86 | −0.0014 | 0.00059 | 1.03 |
| 34 | Example | 1.04 | 5 | 5.61 | 0.97 | −0.0014 | 0.00049 | 5.27 | 0.85 | −0.0015 | 0.00048 | 1.33 |
| 35 | Example | 1.20 | 5 | 5.58 | 0.97 | −0.0014 | 0.00027 | 5.24 | 0.84 | −0.0015 | 0.00028 | 2.76 |
| 36 | Example | 3.00 | 5 | 5.52 | 0.95 | −0.0028 | 0.00016 | 5.20 | 0.84 | −0.0029 | 0.00017 | 2.14 |
| 37 | Comparative Example | 3.50 | 5 | 5.49 | 0.94 | −0.0033 | 0.00012 | 5.14 | 0.82 | −0.0035 | 0.00013 | 1.20 |
| 38 | Comparative Example | 1.20 | 0.4 | 5.30 | 0.93 | −0.0031 | 0.00020 | 4.82 | 0.82 | −0.0033 | 0.00019 | 1.08 |
| 39 | Example | 1.20 | 1.0 | 5.36 | 0.94 | −0.0029 | 0.00021 | 4.88 | 0.83 | −0.0030 | 0.00020 | 1.32 |
| 40 | Example | 1.20 | 2 | 5.40 | 0.95 | −0.0016 | 0.00022 | 4.97 | 0.83 | −0.0017 | 0.00022 | 2.01 |
| 35 | Example | 1.20 | 5 | 5.58 | 0.97 | −0.0014 | 0.00027 | 5.24 | 0.84 | −0.0015 | 0.00028 | 2.76 |
| 42 | Example | 1.20 | 15 | 5.70 | 0.98 | −0.0014 | 0.00038 | 5.53 | 0.87 | −0.0014 | 0.00040 | 2.22 |
| 43 | Example | 1.20 | 30 | 5.87 | 0.98 | −0.0013 | 0.00044 | 5.60 | 0.88 | −0.0014 | 0.00049 | 1.43 |
| 44 | Comparative Example | 1.20 | 32 | 5.98 | 0.98 | −0.0012 | 0.00052 | 5.67 | 0.88 | −0.0013 | 0.00061 | 1.02 |

TABLE 4

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (−) | (m³/MPa) | (μm) | (−) | (−) | (−) | (μm) | (−) | (−) | (−) | (−) |
| 45 | Comparative Example | 1.00 | 5 | 6.59 | 0.97 | −0.0015 | 0.00067 | 6.11 | 0.86 | −0.0016 | 0.00067 | 1.00 |
| 46 | Comparative Example | 1.03 | 5 | 6.57 | 0.97 | −0.0015 | 0.00060 | 6.08 | 0.85 | −0.0016 | 0.00061 | 1.04 |
| 47 | Example | 1.04 | 5 | 6.60 | 0.96 | −0.0015 | 0.00046 | 6.12 | 0.85 | −0.0015 | 0.00050 | 1.32 |
| 48 | Example | 1.20 | 5 | 6.78 | 0.96 | −0.0017 | 0.00020 | 6.24 | 0.85 | −0.0018 | 0.00019 | 2.70 |
| 49 | Example | 3.00 | 5 | 6.56 | 0.95 | −0.0027 | 0.00015 | 6.06 | 0.84 | −0.0025 | 0.00014 | 2.21 |
| 50 | Comparative Example | 3.50 | 5 | 6.75 | 0.94 | −0.0036 | 0.00014 | 6.22 | 0.83 | −0.0032 | 0.00012 | 1.10 |
| 51 | Comparative Example | 1.20 | 0.4 | 6.60 | 0.92 | −0.0033 | 0.00013 | 6.07 | 0.80 | −0.0032 | 0.00012 | 1.11 |
| 52 | Example | 1.20 | 1.0 | 6.64 | 0.94 | −0.0026 | 0.00014 | 6.10 | 0.82 | −0.0025 | 0.00013 | 1.35 |
| 53 | Example | 1.20 | 2 | 6.62 | 0.95 | −0.0020 | 0.00015 | 6.09 | 0.82 | −0.0020 | 0.00014 | 2.15 |
| 48 | Example | 1.20 | 5 | 6.78 | 0.96 | −0.0017 | 0.00020 | 6.24 | 0.85 | −0.0018 | 0.00019 | 2.70 |
| 55 | Example | 1.20 | 15 | 6.75 | 0.97 | −0.0016 | 0.00034 | 6.21 | 0.86 | −0.0017 | 0.00032 | 2.22 |
| 56 | Example | 1.20 | 30 | 6.80 | 0.97 | −0.0014 | 0.00046 | 6.25 | 0.85 | −0.0015 | 0.00046 | 1.58 |
| 57 | Comparative Example | 1.20 | 32 | 6.77 | 0.97 | −0.0014 | 0.00051 | 6.25 | 0.86 | −0.0014 | 0.00052 | 1.07 |

According to Tables 2 to 4, when W2/W1 and Gv/Gp were suitably controlled, the slopes “my” and “mz” of each soft magnetic alloy powder were within the predetermined ranges. The slopes “mY” and “mZ” of the magnetic core (toroidal core) produced using the soft magnetic alloy powder were within the predetermined ranges, and the DC superimposition characteristics were good.

In contrast, when W2/W1 was too small and when Gv/Gp was too large, the absolute value of the slope “mz” of the soft magnetic alloy powder was too large. Moreover, the slope “mZ” of the magnetic core (toroidal core) produced using the soft magnetic alloy powder fell outside the predetermined range, and the DC superimposition characteristics were reduced.

When W2/W1 was too large and when Gv/Gp was too small, the absolute value of the slope “my” of the soft magnetic alloy powder was too large. Moreover, the slope “mY” of the magnetic core (toroidal core) produced using the soft magnetic alloy powder fell outside the predetermined range, and the DC superimposition characteristics were reduced.

### Experiment 3

Experiment 3 was conducted as in Experiment 1 except that the composition of the soft magnetic alloy powder was changed to 64.5Fe-29.2Co-2.4B-1.7Si-1.2P-1.0Cr (Table 5), 64.3Fe-29.1Co-2.4B-1.7Si-1.2P-1.0Cr-0.2C (Table 6), 86.8Fe-11.0Si-2.2B (Table 7), 87.3Fe-7.0Si-2.5Cr-2.5B-0.7C (Table 8), or 94.6Fe-2.0Si-3.0B-0.4C (Table 9) in weight ratio and that the heat treatment was not performed for the soft magnetic alloy powder. It was confirmed that all powders of Experiment 3 had an amorphous structure.

TABLE 5

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (−) | (m³/MPa) | (μm) | (−) | (−) | (−) | (μm) | (−) | (−) | (−) | (−) |
| 58 | Comparative Example | 1.00 | 5 | 7.68 | 0.98 | −0.0015 | 0.00065 | 7.27 | 0.88 | −0.0016 | 0.00063 | 1.00 |
| 59 | Comparative Example | 1.03 | 5 | 7.73 | 0.98 | −0.0015 | 0.00056 | 7.13 | 0.89 | −0.0015 | 0.00054 | 1.05 |
| 60 | Example | 1.04 | 5 | 7.71 | 0.97 | −0.0014 | 0.00046 | 7.29 | 0.87 | −0.0015 | 0.00042 | 1.32 |
| 61 | Example | 1.20 | 5 | 7.72 | 0.97 | −0.0016 | 0.00018 | 7.20 | 0.86 | −0.0016 | 0.00017 | 2.75 |
| 62 | Example | 3.00 | 5 | 7.73 | 0.96 | −0.0028 | 0.00013 | 7.11 | 0.86 | −0.0027 | 0.00013 | 2.24 |
| 63 | Comparative Example | 3.50 | 5 | 7.74 | 0.95 | −0.0033 | 0.00012 | 7.12 | 0.86 | −0.0033 | 0.00013 | 1.20 |
| 64 | Comparative Example | 1.20 | 0.4 | 7.70 | 0.93 | −0.0034 | 0.00011 | 7.08 | 0.82 | −0.0035 | 0.00012 | 1.15 |
| 65 | Example | 1.20 | 1.0 | 7.69 | 0.94 | −0.0029 | 0.00013 | 7.07 | 0.83 | −0.0027 | 0.00013 | 1.36 |
| 66 | Example | 1.20 | 2 | 7.70 | 0.96 | −0.0019 | 0.00015 | 7.09 | 0.85 | −0.0020 | 0.00015 | 2.10 |
| 61 | Example | 1.20 | 5 | 7.72 | 0.97 | −0.0016 | 0.00018 | 7.10 | 0.86 | −0.0016 | 0.00017 | 2.75 |
| 68 | Example | 1.20 | 15 | 7.83 | 0.97 | −0.0014 | 0.00022 | 7.20 | 0.86 | −0.0013 | 0.00023 | 2.31 |
| 69 | Example | 1.20 | 30 | 7.96 | 0.97 | −0.0014 | 0.00045 | 7.32 | 0.86 | −0.0012 | 0.00045 | 1.92 |
| 70 | Comparative Example | 1.20 | 32 | 7.95 | 0.97 | −0.0013 | 0.00051 | 7.31 | 0.87 | −0.0012 | 0.00055 | 1.25 |

TABLE 6

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (−) | (m³/MPa) | (μm) | (−) | (−) | (−) | (μm) | (−) | (−) | (−) | (−) |
| 71 | Comparative Example | 1.00 | 5 | 7.84 | 0.98 | −0.0014 | 0.00062 | 7.23 | 0.87 | −0.0014 | 0.00062 | 1.00 |
| 72 | Comparative Example | 1.03 | 5 | 7.83 | 0.98 | −0.0014 | 0.00054 | 7.21 | 0.87 | −0.0014 | 0.00055 | 1.07 |
| 73 | Example | 1.04 | 5 | 7.86 | 0.98 | −0.0015 | 0.00043 | 7.24 | 0.87 | −0.0015 | 0.00041 | 1.33 |
| 74 | Example | 1.20 | 5 | 7.82 | 0.97 | −0.0015 | 0.00017 | 7.24 | 0.86 | −0.0016 | 0.00018 | 2.65 |
| 75 | Example | 3.00 | 5 | 7.88 | 0.97 | −0.0027 | 0.00017 | 7.26 | 0.86 | −0.0026 | 0.00017 | 2.17 |
| 76 | Comparative Example | 3.50 | 5 | 7.85 | 0.96 | −0.0031 | 0.00014 | 7.28 | 0.86 | −0.0032 | 0.00015 | 1.23 |
| 77 | Comparative Example | 1.20 | 0.4 | 7.84 | 0.94 | −0.0031 | 0.00013 | 7.26 | 0.85 | −0.0032 | 0.00013 | 1.11 |
| 78 | Example | 1.20 | 1.0 | 7.84 | 0.95 | −0.0026 | 0.00012 | 7.23 | 0.85 | −0.0024 | 0.00013 | 1.34 |
| 79 | Example | 1.20 | 2 | 7.85 | 0.96 | −0.0017 | 0.00014 | 7.26 | 0.85 | −0.0018 | 0.00015 | 2.19 |
| 74 | Example | 1.20 | 5 | 7.82 | 0.97 | −0.0015 | 0.00017 | 7.24 | 0.86 | −0.0016 | 0.00018 | 2.65 |
| 81 | Example | 1.20 | 15 | 7.92 | 0.97 | −0.0013 | 0.00021 | 7.29 | 0.86 | −0.0014 | 0.00020 | 2.26 |
| 82 | Example | 1.20 | 30 | 8.02 | 0.98 | −0.0012 | 0.00044 | 7.39 | 0.86 | −0.0013 | 0.00043 | 1.87 |
| 83 | Comparative Example | 1.20 | 32 | 8.03 | 0.98 | −0.0012 | 0.00051 | 7.38 | 0.87 | −0.0012 | 0.00051 | 1.24 |

TABLE 7

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (−) | (m³/MPa) | (μm) | (−) | (−) | (−) | (μm) | (−) | (−) | (−) | (−) |
| 84 | Comparative Example | 1.00 | 5 | 12.14 | 0.97 | −0.0015 | 0.00082 | 11.19 | 0.86 | −0.0018 | 0.00071 | 1.00 |
| 85 | Comparative Example | 1.03 | 5 | 12.16 | 0.97 | −0.0016 | 0.00075 | 11.15 | 0.86 | −0.0017 | 0.00056 | 1.03 |
| 86 | Example | 1.04 | 5 | 12.20 | 0.96 | −0.0017 | 0.00049 | 11.23 | 0.85 | −0.0019 | 0.00048 | 1.34 |
| 87 | Example | 1.20 | 5 | 12.22 | 0.97 | −0.0019 | 0.00017 | 11.22 | 0.84 | −0.0020 | 0.00017 | 2.92 |
| 88 | Example | 3.00 | 5 | 12.18 | 0.95 | −0.0026 | 0.00016 | 11.20 | 0.82 | −0.0026 | 0.00013 | 2.43 |
| 89 | Comparative Example | 3.50 | 5 | 12.25 | 0.93 | −0.0037 | 0.00015 | 11.25 | 0.82 | −0.0031 | 0.00013 | 1.24 |
| 90 | Comparative Example | 1.20 | 0.4 | 11.70 | 0.94 | −0.0035 | 0.00011 | 10.76 | 0.83 | −0.0034 | 0.00011 | 1.22 |
| 91 | Example | 1.20 | 1.0 | 11.76 | 0.94 | −0.0027 | 0.00012 | 10.81 | 0.83 | −0.0027 | 0.00013 | 1.35 |
| 92 | Example | 1.20 | 2 | 11.94 | 0.96 | −0.0023 | 0.00013 | 10.95 | 0.84 | −0.0023 | 0.00014 | 2.29 |
| 87 | Example | 1.20 | 5 | 12.22 | 0.97 | −0.0019 | 0.00017 | 11.22 | 0.84 | −0.0020 | 0.00017 | 2.92 |
| 94 | Example | 1.20 | 15 | 12.50 | 0.98 | −0.0018 | 0.00021 | 11.50 | 0.87 | −0.0019 | 0.00022 | 1.98 |
| 95 | Example | 1.20 | 30 | 12.85 | 0.98 | −0.0014 | 0.00047 | 11.81 | 0.87 | −0.0017 | 0.00045 | 1.65 |
| 96 | Comparative Example | 1.20 | 32 | 12.86 | 0.98 | −0.0013 | 0.00051 | 11.84 | 0.86 | −0.0015 | 0.00053 | 1.08 |

TABLE 8

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 97 | Comparative Example | 1.00 | 5 | 11.25 | 0.97 | −0.0015 | 0.00063 | 10.34 | 0.86 | −0.0016 | 0.00065 | 1.00 |
| 98 | Comparative Example | 1.03 | 5 | 11.19 | 0.97 | −0.0015 | 0.00057 | 10.28 | 0.85 | −0.0017 | 0.00055 | 1.04 |
| 99 | Example | 1.04 | 5 | 11.23 | 0.96 | −0.0016 | 0.00048 | 10.31 | 0.85 | −0.0017 | 0.00045 | 1.34 |
| 100 | Example | 1.20 | 5 | 11.23 | 0.96 | −0.0017 | 0.00018 | 10.30 | 0.85 | −0.0019 | 0.00017 | 2.75 |
| 101 | Example | 3.00 | 5 | 11.26 | 0.95 | −0.0027 | 0.00013 | 10.35 | 0.84 | −0.0028 | 0.00016 | 2.15 |
| 102 | Comparative Example | 3.50 | 5 | 11.29 | 0.94 | −0.0034 | 0.00013 | 10.38 | 0.83 | −0.0036 | 0.00015 | 1.21 |
| 103 | Comparative Example | 1.20 | 0.4 | 10.22 | 0.93 | −0.0032 | 0.00013 | 9.38 | 0.83 | −0.0032 | 0.00012 | 1.23 |
| 104 | Example | 1.20 | 1.0 | 10.78 | 0.94 | −0.0025 | 0.00014 | 9.92 | 0.83 | −0.0024 | 0.00014 | 1.33 |
| 105 | Example | 1.20 | 2 | 10.91 | 0.95 | −0.0020 | 0.00014 | 10.03 | 0.83 | −0.0021 | 0.00014 | 2.19 |
| 100 | Example | 1.20 | 5 | 11.23 | 0.96 | −0.0017 | 0.00018 | 10.30 | 0.85 | −0.0019 | 0.00017 | 2.75 |
| 107 | Example | 1.20 | 15 | 11.89 | 0.97 | −0.0015 | 0.00020 | 10.95 | 0.85 | −0.0016 | 0.00021 | 2.30 |
| 108 | Example | 1.20 | 30 | 12.24 | 0.97 | −0.0014 | 0.00042 | 11.25 | 0.86 | −0.0015 | 0.00039 | 1.39 |
| 109 | Comparative Example | 1.20 | 32 | 12.30 | 0.98 | −0.0013 | 0.00051 | 11.32 | 0.86 | −0.0015 | 0.00053 | 1.07 |

TABLE 9

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 110 | Comparative Example | 1.00 | 5 | 14.15 | 0.97 | −0.0015 | 0.00063 | 13.02 | 0.86 | −0.0015 | 0.00066 | 1.00 |
| 111 | Comparative Example | 1.03 | 5 | 14.25 | 0.96 | −0.0016 | 0.00057 | 13.14 | 0.85 | −0.0016 | 0.00058 | 1.05 |
| 112 | Example | 1.04 | 5 | 14.21 | 0.97 | −0.0016 | 0.00045 | 13.09 | 0.85 | −0.0017 | 0.00045 | 1.35 |
| 113 | Example | 1.20 | 5 | 14.18 | 0.96 | −0.0018 | 0.00021 | 13.06 | 0.85 | −0.0019 | 0.00022 | 2.54 |
| 114 | Example | 3.00 | 5 | 14.29 | 0.95 | −0.0027 | 0.00013 | 13.17 | 0.84 | −0.0026 | 0.00014 | 1.35 |
| 115 | Comparative Example | 3.50 | 5 | 14.20 | 0.94 | −0.0031 | 0.00013 | 13.11 | 0.83 | −0.0034 | 0.00015 | 1.21 |
| 116 | Comparative Example | 1.20 | 0.4 | 13.47 | 0.94 | −0.0031 | 0.00015 | 12.42 | 0.83 | −0.0032 | 0.00015 | 1.24 |
| 117 | Example | 1.20 | 1.0 | 13.66 | 0.95 | −0.0025 | 0.00017 | 15.56 | 0.84 | −0.0028 | 0.00016 | 1.37 |
| 118 | Example | 1.20 | 2 | 13.93 | 0.96 | −0.0020 | 0.00017 | 12.79 | 0.84 | −0.0021 | 0.00017 | 1.97 |
| 113 | Example | 1.20 | 5 | 14.18 | 0.96 | −0.0018 | 0.00021 | 13.06 | 0.85 | −0.0019 | 0.00022 | 2.54 |
| 120 | Example | 1.20 | 15 | 15.13 | 0.98 | −0.0017 | 0.00024 | 13.89 | 0.86 | −0.0017 | 0.00025 | 1.98 |
| 121 | Example | 1.20 | 30 | 16.11 | 0.98 | −0.0016 | 0.00046 | 14.75 | 0.86 | −0.0015 | 0.00047 | 1.54 |
| 122 | Comparative Example | 1.20 | 32 | 16.36 | 0.98 | −0.0016 | 0.00062 | 15.04 | 0.87 | −0.0015 | 0.00069 | 1.23 |

According to Tables 5 to 9, when W2/W1 and Gv/Gp were suitably controlled, the slopes “my” and “mz” of each soft magnetic alloy powder were within the predetermined ranges. The slopes “mY” and “mZ” of the magnetic core (toroidal core) produced using the soft magnetic alloy powder were within the predetermined ranges, and the DC superimposition characteristics were good.

In contrast, when W2/W1 was too small and when Gv/Gp was too large, the absolute value of the slope “mz” of the soft magnetic alloy powder was too large. Moreover, the slope “mZ” of the magnetic core (toroidal core) produced using the soft magnetic alloy powder fell outside the predetermined range, and the DC superimposition characteristics were reduced.

When W2/W1 was too large and when Gv/Gp was too small, the absolute value of the slope “my” of the soft magnetic alloy powder was too large. Moreover, the slope “mY” of the magnetic core (toroidal core) produced using the soft magnetic alloy powder fell outside the predetermined range, and the DC superimposition characteristics were reduced.

### Experiment 4

Experiment 4 was conducted as in Experiment 1 except that the composition of the soft magnetic alloy powder was changed to 97.0Fe-3.0Si (Table 10), 95.5Fe-4.5Si (Table 11), 93.5Fe-6.5Si (Table 12), 84.2Fe-9.3Co-6.5Si (Table 13), 83.3Fe-9.2Co-6.5Si-1.0Cr (Table 14), 55.0Fe-45.0Ni (Table 15), 16.0Fe-79.0Ni-5.0Mo (Table 16), 93.5Fe-4.5Si-2.0Cr (Table 17), 85.5Fe-4.5Si-10.0Cr (Table 18), 85.0Fe-9.5Si-5.5Al (Table 19), 87.4Fe-6.2Si-5.4Al-1.0Ni (Table 20), or 49.0Fe-44.0Ni-2.0Si-5.0Co (Table 21) in weight ratio and that the heat treatment was not performed for the soft magnetic alloy powder. It was confirmed that all powders of Experiment 4 had a crystalline structure.

TABLE 10

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 123 | Comparative Example | 1.00 | 5 | 4.31 | 0.93 | −0.0025 | 0.00067 | 4.01 | 0.74 | −0.0023 | 0.00064 | 1.00 |
| 124 | Comparative Example | 1.03 | 5 | 4.35 | 0.93 | −0.0026 | 0.00062 | 4.06 | 0.73 | −0.0024 | 0.00059 | 1.06 |
| 125 | Example | 1.04 | 5 | 4.40 | 0.92 | −0.0027 | 0.00048 | 4.09 | 0.73 | −0.0025 | 0.00043 | 1.34 |
| 126 | Example | 1.20 | 5 | 4.61 | 0.91 | −0.0027 | 0.00023 | 4.23 | 0.73 | −0.0027 | 0.00024 | 2.13 |
| 127 | Example | 3.00 | 5 | 4.39 | 0.89 | −0.0030 | 0.00019 | 4.10 | 0.71 | −0.0029 | 0.00018 | 1.36 |
| 128 | Comparative Example | 3.50 | 5 | 4.41 | 0.88 | −0.0032 | 0.00018 | 3.88 | 0.71 | −0.0031 | 0.00018 | 1.14 |
| 129 | Comparative Example | 1.20 | 0.4 | 4.12 | 0.88 | −0.0042 | 0.00019 | 3.77 | 0.70 | −0.0039 | 0.00018 | 1.08 |
| 130 | Example | 1.20 | 1.0 | 4.39 | 0.89 | −0.0029 | 0.00020 | 3.99 | 0.71 | −0.0029 | 0.00019 | 1.31 |
| 131 | Example | 1.20 | 2 | 4.45 | 0.90 | −0.0029 | 0.00020 | 4.14 | 0.72 | −0.0028 | 0.00022 | 1.87 |
| 126 | Example | 1.20 | 5 | 4.61 | 0.91 | −0.0027 | 0.00023 | 4.23 | 0.73 | −0.0027 | 0.00024 | 2.13 |
| 133 | Example | 1.20 | 15 | 4.93 | 0.93 | −0.0024 | 0.00025 | 4.51 | 0.74 | −0.0025 | 0.00027 | 1.54 |
| 134 | Example | 1.20 | 30 | 5.34 | 0.95 | −0.0019 | 0.00047 | 4.89 | 0.75 | −0.0021 | 0.00045 | 1.31 |
| 135 | Comparative Example | 1.20 | 32 | 5.50 | 0.95 | −0.0018 | 0.00053 | 5.01 | 0.76 | −0.0019 | 0.00054 | 1.19 |

TABLE 11

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 136 | Comparative Example | 1.00 | 5 | 9.34 | 0.95 | −0.0018 | 0.00065 | 8.54 | 0.76 | −0.0019 | 0.00070 | 1.00 |
| 137 | Comparative Example | 1.03 | 5 | 9.44 | 0.94 | −0.0019 | 0.00058 | 8.61 | 0.75 | −0.0020 | 0.00059 | 1.07 |
| 138 | Example | 1.04 | 5 | 9.41 | 0.94 | −0.0021 | 0.00047 | 8.58 | 0.74 | −0.0022 | 0.00049 | 1.35 |
| 139 | Example | 1.20 | 5 | 9.44 | 0.93 | −0.0023 | 0.00022 | 8.65 | 0.74 | −0.0024 | 0.00023 | 2.29 |
| 140 | Example | 3.00 | 5 | 9.50 | 0.93 | −0.0028 | 0.00016 | 8.69 | 0.74 | −0.0029 | 0.00021 | 1.54 |
| 141 | Comparative Example | 3.50 | 5 | 9.47 | 0.94 | −0.0032 | 0.00015 | 8.70 | 0.73 | −0.0034 | 0.00020 | 1.29 |
| 142 | Comparative Example | 1.20 | 0.4 | 9.13 | 0.90 | −0.0040 | 0.00017 | 8.37 | 0.72 | −0.0040 | 0.00018 | 1.11 |
| 143 | Example | 1.20 | 1.0 | 9.20 | 0.91 | −0.0029 | 0.00018 | 8.42 | 0.72 | −0.0028 | 0.00019 | 1.40 |
| 144 | Example | 1.20 | 2 | 9.23 | 0.91 | −0.0026 | 0.00019 | 8.46 | 0.73 | −0.0026 | 0.00020 | 1.54 |
| 139 | Example | 1.20 | 5 | 9.44 | 0.93 | −0.0023 | 0.00022 | 8.65 | 0.74 | −0.0024 | 0.00023 | 2.29 |
| 146 | Example | 1.20 | 15 | 9.58 | 0.94 | −0.0020 | 0.00024 | 8.84 | 0.75 | −0.0021 | 0.00024 | 1.89 |
| 147 | Example | 1.20 | 30 | 9.69 | 0.95 | −0.0019 | 0.00048 | 8.88 | 0.77 | −0.0019 | 0.00045 | 1.35 |
| 148 | Comparative Example | 1.20 | 32 | 9.71 | 0.95 | −0.0018 | 0.00052 | 8.90 | 0.77 | −0.0019 | 0.00058 | 1.06 |

TABLE 12

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 149 | Comparative Example | 1.00 | 5 | 9.64 | 0.95 | −0.0018 | 0.00066 | 8.89 | 0.74 | −0.0017 | 0.00067 | 1.00 |
| 150 | Comparative Example | 1.03 | 5 | 9.68 | 0.95 | −0.0019 | 0.00055 | 8.90 | 0.75 | −0.0019 | 0.00056 | 1.05 |
| 151 | Example | 1.04 | 5 | 9.72 | 0.94 | −0.0022 | 0.00043 | 8.93 | 0.75 | −0.0022 | 0.00041 | 1.36 |
| 152 | Example | 1.20 | 5 | 9.62 | 0.94 | −0.0024 | 0.00025 | 8.83 | 0.75 | −0.0024 | 0.00025 | 2.44 |
| 153 | Example | 3.00 | 5 | 9.77 | 0.93 | −0.0029 | 0.00015 | 9.01 | 0.74 | −0.0030 | 0.00016 | 1.43 |
| 154 | Comparative Example | 3.50 | 5 | 9.84 | 0.93 | −0.0034 | 0.00013 | 9.09 | 0.73 | −0.0035 | 0.00014 | 1.23 |
| 155 | Comparative Example | 1.20 | 0.4 | 9.35 | 0.91 | −0.0040 | 0.00018 | 8.66 | 0.73 | −0.0039 | 0.00019 | 1.13 |
| 156 | Example | 1.20 | 1.0 | 9.41 | 0.92 | −0.0029 | 0.00019 | 8.69 | 0.74 | −0.0028 | 0.00020 | 1.35 |
| 157 | Example | 1.20 | 2 | 9.48 | 0.92 | −0.0027 | 0.00020 | 8.75 | 0.74 | −0.0026 | 0.00021 | 1.92 |
| 152 | Example | 1.20 | 5 | 9.62 | 0.94 | −0.0024 | 0.00025 | 8.83 | 0.75 | −0.0024 | 0.00025 | 2.44 |
| 159 | Example | 1.20 | 15 | 9.70 | 0.95 | −0.0020 | 0.00027 | 8.90 | 0.76 | −0.0021 | 0.00028 | 1.70 |
| 160 | Example | 1.20 | 30 | 10.76 | 0.96 | −0.0018 | 0.00048 | 9.92 | 0.77 | −0.0019 | 0.00049 | 1.31 |
| 161 | Comparative Example | 1.20 | 32 | 10.93 | 0.96 | −0.0018 | 0.00051 | 10.05 | 0.77 | −0.0018 | 0.00051 | 1.22 |

TABLE 13

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 162 | Comparative Example | 1.00 | 5 | 10.04 | 0.95 | −0.0017 | 0.00061 | 9.24 | 0.85 | −0.0016 | 0.00061 | 1.00 |
| 163 | Comparative Example | 1.03 | 5 | 10.08 | 0.95 | −0.0018 | 0.00053 | 9.25 | 0.85 | −0.0016 | 0.00052 | 1.02 |
| 164 | Example | 1.04 | 5 | 10.07 | 0.94 | −0.0023 | 0.00045 | 9.25 | 0.85 | −0.0023 | 0.00042 | 1.31 |
| 165 | Example | 1.20 | 5 | 10.03 | 0.95 | −0.0025 | 0.00024 | 9.23 | 0.84 | −0.0024 | 0.00023 | 2.23 |
| 166 | Example | 3.00 | 5 | 10.11 | 0.94 | −0.0028 | 0.00017 | 9.28 | 0.84 | −0.0027 | 0.00018 | 1.45 |
| 167 | Comparative Example | 3.50 | 5 | 10.09 | 0.93 | −0.0032 | 0.00014 | 9.27 | 0.83 | −0.0031 | 0.00016 | 1.21 |
| 168 | Comparative Example | 1.20 | 0.4 | 9.82 | 0.92 | −0.0038 | 0.00017 | 9.05 | 0.83 | −0.0035 | 0.00017 | 1.15 |
| 169 | Example | 1.20 | 1.0 | 9.85 | 0.93 | −0.0028 | 0.00019 | 9.07 | 0.83 | −0.0029 | 0.00018 | 1.32 |
| 170 | Example | 1.20 | 2 | 9.92 | 0.94 | −0.0026 | 0.00022 | 9.11 | 0.84 | −0.0026 | 0.00021 | 1.98 |
| 165 | Example | 1.20 | 5 | 10.03 | 0.95 | −0.0025 | 0.00024 | 9.25 | 0.84 | −0.0024 | 0.00023 | 2.23 |
| 172 | Example | 1.20 | 15 | 10.09 | 0.95 | −0.0020 | 0.00028 | 9.28 | 0.85 | −0.0019 | 0.00027 | 1.81 |
| 173 | Example | 1.20 | 30 | 10.88 | 0.96 | −0.0018 | 0.00046 | 10.00 | 0.85 | −0.0017 | 0.00046 | 1.36 |
| 174 | Comparative Example | 1.20 | 32 | 10.92 | 0.95 | −0.0017 | 0.00054 | 10.03 | 0.85 | −0.0017 | 0.00052 | 1.26 |

TABLE 14

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 175 | Comparative Example | 1.00 | 5 | 10.05 | 0.96 | −0.0016 | 0.00059 | 9.21 | 0.86 | −0.0016 | 0.00058 | 1.00 |
| 176 | Comparative Example | 1.03 | 5 | 10.06 | 0.95 | −0.0016 | 0.00052 | 9.23 | 0.85 | −0.0017 | 0.00051 | 1.04 |
| 177 | Example | 1.04 | 5 | 10.02 | 0.95 | −0.0021 | 0.00043 | 9.22 | 0.85 | −0.0020 | 0.00042 | 1.33 |
| 178 | Example | 1.20 | 5 | 10.08 | 0.95 | −0.0024 | 0.00025 | 9.24 | 0.85 | −0.0025 | 0.00025 | 2.54 |
| 179 | Example | 3.00 | 5 | 10.09 | 0.94 | −0.0027 | 0.00020 | 9.29 | 0.84 | −0.0028 | 0.00021 | 1.68 |
| 180 | Comparative Example | 3.50 | 5 | 10.12 | 0.94 | −0.0031 | 0.00015 | 9.30 | 0.84 | −0.0036 | 0.00017 | 1.26 |
| 181 | Comparative Example | 1.20 | 0.4 | 9.93 | 0.93 | −0.0034 | 0.00018 | 9.15 | 0.83 | −0.0037 | 0.00016 | 1.18 |
| 182 | Example | 1.20 | 1.0 | 9.99 | 0.93 | −0.0026 | 0.00019 | 9.18 | 0.83 | −0.0028 | 0.00018 | 1.39 |
| 183 | Example | 1.20 | 2 | 10.01 | 0.94 | −0.0025 | 0.00023 | 9.21 | 0.84 | −0.0027 | 0.00022 | 1.95 |
| 178 | Example | 1.20 | 5 | 10.08 | 0.95 | −0.0024 | 0.00025 | 9.24 | 0.85 | −0.0025 | 0.00025 | 2.54 |
| 185 | Example | 1.20 | 15 | 10.12 | 0.95 | −0.0021 | 0.00029 | 9.29 | 0.85 | −0.0022 | 0.00028 | 1.66 |
| 186 | Example | 1.20 | 30 | 11.01 | 0.95 | −0.0019 | 0.00045 | 10.09 | 0.85 | −0.0018 | 0.00043 | 1.32 |
| 187 | Comparative Example | 1.20 | 32 | 11.13 | 0.96 | −0.0018 | 0.00052 | 10.22 | 0.86 | −0.0017 | 0.00051 | 1.19 |

TABLE 15

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 188 | Comparative Example | 1.00 | 5 | 9.40 | 0.95 | −0.0019 | 0.00061 | 8.63 | 0.76 | −0.0020 | 0.00060 | 1.00 |
| 189 | Comparative Example | 1.03 | 5 | 9.38 | 0.94 | −0.0021 | 0.00052 | 8.60 | 0.75 | −0.0022 | 0.00049 | 1.04 |
| 190 | Example | 1.04 | 5 | 9.42 | 0.94 | −0.0023 | 0.00044 | 8.68 | 0.74 | −0.0023 | 0.00041 | 1.36 |
| 191 | Example | 1.20 | 5 | 9.45 | 0.93 | −0.0026 | 0.00024 | 8.74 | 0.74 | −0.0026 | 0.00024 | 2.34 |
| 192 | Example | 3.00 | 5 | 9.51 | 0.93 | −0.0029 | 0.00020 | 8.76 | 0.73 | −0.0029 | 0.00019 | 1.89 |
| 193 | Comparative Example | 3.50 | 5 | 9.54 | 0.92 | −0.0036 | 0.00019 | 8.81 | 0.73 | −0.0035 | 0.00019 | 1.21 |
| 194 | Comparative Example | 1.20 | 0.4 | 9.19 | 0.90 | −0.0043 | 0.00018 | 8.46 | 0.72 | −0.0043 | 0.00017 | 1.28 |
| 195 | Example | 1.20 | 1.0 | 9.24 | 0.91 | −0.0029 | 0.00019 | 8.52 | 0.73 | −0.0030 | 0.00019 | 1.31 |
| 196 | Example | 1.20 | 2 | 9.31 | 0.91 | −0.0029 | 0.00019 | 8.54 | 0.73 | −0.0030 | 0.00020 | 1.77 |
| 191 | Example | 1.20 | 5 | 9.45 | 0.93 | −0.0026 | 0.00024 | 8.74 | 0.74 | −0.0026 | 0.00024 | 2.34 |
| 198 | Example | 1.20 | 15 | 9.72 | 0.94 | −0.0023 | 0.00025 | 8.92 | 0.75 | −0.0024 | 0.00027 | 1.75 |
| 199 | Example | 1.20 | 30 | 10.25 | 0.95 | −0.0020 | 0.00045 | 9.44 | 0.77 | −0.0021 | 0.00046 | 1.31 |
| 200 | Comparative Example | 1.20 | 32 | 10.31 | 0.95 | −0.0020 | 0.00053 | 9.49 | 0.76 | −0.0020 | 0.00053 | 1.19 |

TABLE 16

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 201 | Comparative Example | 1.00 | 5 | 9.72 | 0.93 | −0.0022 | 0.00063 | 8.88 | 0.73 | −0.0021 | 0.00065 | 1.00 |
| 202 | Comparative Example | 1.03 | 5 | 9.74 | 0.93 | −0.0023 | 0.00054 | 8.95 | 0.73 | −0.0024 | 0.00057 | 1.03 |
| 203 | Example | 1.04 | 5 | 9.71 | 0.93 | −0.0024 | 0.00047 | 8.90 | 0.73 | −0.0025 | 0.00049 | 1.31 |
| 204 | Example | 1.20 | 5 | 9.75 | 0.92 | −0.0026 | 0.00025 | 9.00 | 0.72 | −0.0027 | 0.00024 | 2.02 |
| 205 | Example | 3.00 | 5 | 9.75 | 0.92 | −0.0028 | 0.00019 | 8.98 | 0.72 | −0.0029 | 0.00020 | 1.68 |
| 206 | Comparative Example | 3.50 | 5 | 9.82 | 0.92 | −0.0031 | 0.00018 | 9.05 | 0.72 | −0.0035 | 0.00019 | 1.16 |
| 207 | Comparative Example | 1.20 | 0.4 | 9.53 | 0.89 | −0.0031 | 0.00019 | 8.73 | 0.71 | −0.0032 | 0.00017 | 1.23 |
| 208 | Example | 1.20 | 1.0 | 9.57 | 0.90 | −0.0029 | 0.00020 | 8.77 | 0.71 | −0.0029 | 0.00018 | 1.35 |
| 209 | Example | 1.20 | 2 | 9.64 | 0.91 | −0.0028 | 0.00021 | 8.77 | 0.71 | −0.0029 | 0.00020 | 1.53 |
| 204 | Example | 1.20 | 5 | 9.75 | 0.92 | −0.0026 | 0.00025 | 9.00 | 0.72 | −0.0027 | 0.00024 | 2.02 |
| 211 | Example | 1.20 | 15 | 9.98 | 0.94 | −0.0025 | 0.00026 | 9.19 | 0.74 | −0.0026 | 0.00027 | 1.67 |
| 212 | Example | 1.20 | 30 | 10.21 | 0.95 | −0.0022 | 0.00046 | 9.45 | 0.75 | −0.0023 | 0.00043 | 1.32 |
| 213 | Comparative Example | 1.20 | 32 | 10.25 | 0.96 | −0.0020 | 0.00053 | 9.46 | 0.76 | −0.0022 | 0.00054 | 1.10 |

TABLE 17

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 214 | Comparative Example | 1.00 | 5 | 4.73 | 0.94 | −0.0019 | 0.00069 | 4.37 | 0.76 | −0.0020 | 0.00070 | 1.00 |
| 215 | Comparative Example | 1.03 | 5 | 4.79 | 0.94 | −0.0021 | 0.00058 | 4.41 | 0.76 | −0.0021 | 0.00061 | 1.01 |
| 216 | Example | 1.04 | 5 | 4.61 | 0.93 | −0.0022 | 0.00048 | 4.23 | 0.75 | −0.0024 | 0.00049 | 1.30 |
| 217 | Example | 1.20 | 5 | 4.69 | 0.92 | −0.0024 | 0.00027 | 4.33 | 0.74 | −0.0026 | 0.00026 | 2.16 |
| 218 | Example | 3.00 | 5 | 4.77 | 0.92 | −0.0028 | 0.00020 | 4.37 | 0.74 | −0.0030 | 0.00018 | 1.75 |
| 219 | Comparative Example | 3.50 | 5 | 4.65 | 0.92 | −0.0031 | 0.00019 | 4.24 | 0.73 | −0.0036 | 0.00015 | 1.24 |
| 220 | Comparative Example | 1.20 | 0.4 | 4.52 | 0.88 | −0.0035 | 0.00020 | 4.14 | 0.70 | −0.0035 | 0.00019 | 1.21 |
| 221 | Example | 1.20 | 1.0 | 4.57 | 0.89 | −0.0029 | 0.00021 | 4.18 | 0.71 | −0.0030 | 0.00020 | 1.39 |
| 222 | Example | 1.20 | 2 | 4.62 | 0.90 | −0.0028 | 0.00022 | 4.21 | 0.72 | −0.0029 | 0.00021 | 1.58 |
| 217 | Example | 1.20 | 5 | 4.69 | 0.92 | −0.0024 | 0.00027 | 4.33 | 0.74 | −0.0026 | 0.00026 | 2.16 |
| 224 | Example | 1.20 | 15 | 5.04 | 0.94 | −0.0022 | 0.00030 | 4.56 | 0.75 | −0.0023 | 0.00029 | 1.72 |
| 225 | Example | 1.20 | 30 | 5.95 | 0.95 | −0.0018 | 0.00044 | 5.47 | 0.75 | −0.0019 | 0.00045 | 1.36 |
| 226 | Comparative Example | 1.20 | 32 | 6.13 | 0.96 | −0.0017 | 0.00051 | 5.61 | 0.76 | −0.0019 | 0.00052 | 1.28 |

TABLE 18

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 227 | Comparative Example | 1.00 | 5 | 5.41 | 0.94 | −0.0019 | 0.00067 | 4.90 | 0.75 | −0.0019 | 0.00066 | 1.00 |
| 228 | Comparative Example | 1.03 | 5 | 5.39 | 0.94 | −0.0020 | 0.00054 | 4.88 | 0.75 | −0.0020 | 0.00054 | 1.05 |
| 229 | Example | 1.04 | 5 | 5.44 | 0.93 | −0.0022 | 0.00045 | 4.91 | 0.74 | −0.0023 | 0.00046 | 1.31 |
| 230 | Example | 1.20 | 5 | 5.40 | 0.93 | −0.0024 | 0.00026 | 4.97 | 0.74 | −0.0025 | 0.00025 | 2.35 |
| 231 | Example | 3.00 | 5 | 5.51 | 0.92 | −0.0029 | 0.00021 | 5.11 | 0.74 | −0.0029 | 0.00020 | 1.82 |
| 232 | Comparative Example | 3.50 | 5 | 5.48 | 0.92 | −0.0032 | 0.00020 | 5.03 | 0.74 | −0.0033 | 0.00018 | 1.28 |
| 233 | Comparative Example | 1.20 | 0.4 | 5.11 | 0.90 | −0.0033 | 0.00019 | 4.61 | 0.72 | −0.0032 | 0.00019 | 1.27 |
| 234 | Example | 1.20 | 1.0 | 5.15 | 0.91 | −0.0028 | 0.00020 | 4.65 | 0.72 | −0.0029 | 0.00020 | 1.37 |
| 235 | Example | 1.20 | 2 | 5.23 | 0.91 | −0.0026 | 0.00020 | 4.72 | 0.73 | −0.0027 | 0.00020 | 1.60 |
| 230 | Example | 1.20 | 5 | 5.40 | 0.93 | −0.0024 | 0.00026 | 4.97 | 0.74 | −0.0025 | 0.00025 | 2.35 |
| 237 | Example | 1.20 | 15 | 5.76 | 0.94 | −0.0022 | 0.00029 | 5.34 | 0.75 | −0.0023 | 0.00028 | 1.52 |
| 238 | Example | 1.20 | 30 | 6.13 | 0.95 | −0.0019 | 0.00045 | 5.42 | 0.75 | −0.0021 | 0.00044 | 1.33 |
| 239 | Comparative Example | 1.20 | 32 | 6.18 | 0.95 | −0.0018 | 0.00052 | 5.45 | 0.76 | −0.0020 | 0.00051 | 1.15 |

TABLE 19

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 240 | Comparative Example | 1.00 | 5 | 11.13 | 0.96 | −0.0019 | 0.00065 | 10.21 | 0.76 | −0.0017 | 0.00065 | 1.00 |
| 241 | Comparative Example | 1.03 | 5 | 11.01 | 0.96 | −0.0021 | 0.00051 | 10.13 | 0.76 | −0.0018 | 0.00053 | 1.06 |
| 242 | Example | 1.04 | 5 | 11.28 | 0.95 | −0.0023 | 0.00039 | 10.36 | 0.75 | −0.0021 | 0.00042 | 1.35 |
| 243 | Example | 1.20 | 5 | 11.22 | 0.94 | −0.0025 | 0.00025 | 10.28 | 0.75 | −0.0023 | 0.00024 | 2.51 |
| 244 | Example | 3.00 | 5 | 11.38 | 0.94 | −0.0028 | 0.00021 | 10.45 | 0.74 | −0.0027 | 0.00020 | 1.88 |
| 245 | Comparative Example | 3.50 | 5 | 11.25 | 0.93 | −0.0031 | 0.00017 | 10.35 | 0.73 | −0.0031 | 0.00017 | 1.24 |
| 246 | Comparative Example | 1.20 | 0.4 | 10.89 | 0.92 | −0.0032 | 0.00018 | 10.02 | 0.74 | −0.0031 | 0.00017 | 1.28 |
| 247 | Example | 1.20 | 1.0 | 10.95 | 0.92 | −0.0029 | 0.00019 | 10.67 | 0.74 | −0.0029 | 0.00019 | 1.33 |
| 248 | Example | 1.20 | 2 | 11.04 | 0.93 | −0.0026 | 0.00020 | 10.16 | 0.74 | −0.0025 | 0.00020 | 1.57 |
| 243 | Example | 1.20 | 5 | 11.22 | 0.94 | −0.0025 | 0.00025 | 10.28 | 0.75 | −0.0023 | 0.00024 | 2.51 |
| 250 | Example | 1.20 | 15 | 11.56 | 0.96 | −0.0024 | 0.00028 | 10.66 | 0.77 | −0.0022 | 0.00027 | 1.95 |
| 251 | Example | 1.20 | 30 | 11.62 | 0.97 | −0.0020 | 0.00042 | 10.71 | 0.77 | −0.0019 | 0.00044 | 1.40 |
| 252 | Comparative Example | 1.20 | 32 | 11.67 | 0.97 | −0.0019 | 0.00051 | 10.77 | 0.77 | −0.0019 | 0.00053 | 1.26 |

TABLE 20

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 253 | Comparative Example | 1.00 | 5 | 10.19 | 0.96 | −0.0017 | 0.00065 | 9.36 | 0.76 | −0.0018 | 0.00061 | 1.00 |
| 254 | Comparative Example | 1.03 | 5 | 10.11 | 0.96 | −0.0019 | 0.00052 | 9.30 | 0.76 | −0.0019 | 0.00053 | 1.02 |
| 255 | Example | 1.04 | 5 | 10.09 | 0.95 | −0.0021 | 0.00041 | 9.29 | 0.75 | −0.0021 | 0.00042 | 1.31 |
| 256 | Example | 1.20 | 5 | 10.14 | 0.94 | −0.0023 | 0.00024 | 9.28 | 0.75 | −0.0024 | 0.00023 | 2.46 |
| 257 | Example | 3.00 | 5 | 10.22 | 0.94 | −0.0029 | 0.00019 | 9.36 | 0.75 | −0.0029 | 0.00019 | 1.68 |
| 258 | Comparative Example | 3.50 | 5 | 10.28 | 0.94 | −0.0039 | 0.00017 | 9.41 | 0.74 | −0.0037 | 0.00018 | 1.22 |
| 259 | Comparative Example | 1.20 | 0.4 | 9.83 | 0.91 | −0.0031 | 0.00017 | 9.02 | 0.73 | −0.0031 | 0.00018 | 1.28 |
| 260 | Example | 1.20 | 1.0 | 9.89 | 0.92 | −0.0027 | 0.00019 | 9.09 | 0.73 | −0.0028 | 0.00018 | 1.36 |
| 261 | Example | 1.20 | 2 | 9.92 | 0.92 | −0.0025 | 0.00019 | 9.10 | 0.74 | −0.0026 | 0.00019 | 1.78 |
| 256 | Example | 1.20 | 5 | 10.14 | 0.94 | −0.0023 | 0.00024 | 9.28 | 0.75 | −0.0024 | 0.00023 | 2.46 |
| 263 | Example | 1.20 | 15 | 10.27 | 0.95 | −0.0021 | 0.00026 | 9.49 | 0.76 | −0.0021 | 0.00027 | 1.54 |
| 264 | Example | 1.20 | 30 | 10.87 | 0.95 | −0.0019 | 0.00045 | 10.03 | 0.76 | −0.0018 | 0.00047 | 1.34 |
| 265 | Comparative Example | 1.20 | 32 | 10.91 | 0.95 | −0.0018 | 0.00051 | 10.14 | 0.76 | −0.0017 | 0.00058 | 1.18 |

TABLE 21

| | | | | Soft magnetic alloy powder | | | | Magnetic core | | | | |
|---|---|---|---|---|---|---|---|---|---|---|---|---|
| | | Powder manufacturing | | Average | Average | | | Average | Average | | | μHdc |
| | | conditions | | particle | circularity | | | particle | circularity | | | increase |
| Sample | Example/ | W2/W1 | Gv/Gp | size D1 | C1 | my | mz | size D2 | C2 | mY | mZ | rate |
| No. | Comparative Example | (—) | (m³/MPa) | (μm) | (—) | (—) | (—) | (μm) | (—) | (—) | (—) | (—) |
| 266 | Comparative Example | 1.00 | 5 | 10.83 | 0.95 | −0.0015 | 0.00069 | 9.95 | 0.76 | −0.0016 | 0.00069 | 1.00 |
| 267 | Comparative Example | 1.03 | 5 | 10.78 | 0.95 | −0.0017 | 0.00057 | 9.92 | 0.76 | −0.0018 | 0.00058 | 1.07 |
| 268 | Example | 1.04 | 5 | 10.74 | 0.94 | −0.0021 | 0.00049 | 9.89 | 0.75 | −0.0022 | 0.00047 | 1.35 |
| 269 | Example | 1.20 | 5 | 10.85 | 0.93 | −0.0027 | 0.00025 | 10.02 | 0.74 | −0.0028 | 0.00024 | 2.38 |
| 270 | Example | 3.00 | 5 | 10.95 | 0.93 | −0.0029 | 0.00020 | 10.08 | 0.74 | −0.0029 | 0.00019 | 1.31 |
| 271 | Comparative Example | 3.50 | 5 | 10.91 | 0.92 | −0.0035 | 0.00019 | 10.02 | 0.73 | −0.0034 | 0.00018 | 1.22 |
| 272 | Comparative Example | 1.20 | 0.4 | 10.56 | 0.91 | −0.0036 | 0.00018 | 9.72 | 0.73 | −0.0035 | 0.00016 | 1.21 |
| 273 | Example | 1.20 | 1.0 | 10.61 | 0.92 | −0.0030 | 0.00018 | 9.77 | 0.73 | −0.0030 | 0.00017 | 1.32 |
| 274 | Example | 1.20 | 2 | 10.71 | 0.92 | −0.0029 | 0.00019 | 9.76 | 0.74 | −0.0029 | 0.00018 | 1.89 |
| 269 | Example | 1.20 | 5 | 10.85 | 0.93 | −0.0027 | 0.00025 | 10.02 | 0.74 | −0.0028 | 0.00024 | 2.38 |
| 276 | Example | 1.20 | 15 | 11.36 | 0.94 | −0.0023 | 0.00027 | 10.43 | 0.75 | −0.0024 | 0.00026 | 1.64 |
| 277 | Example | 1.20 | 30 | 12.23 | 0.95 | −0.0020 | 0.00044 | 11.23 | 0.75 | −0.0022 | 0.00044 | 1.33 |
| 278 | Comparative Example | 1.20 | 32 | 12.25 | 0.95 | −0.0020 | 0.00051 | 11.27 | 0.76 | −0.0021 | 0.00052 | 1.19 |

According to Tables 10 to 21, when W2/W1 and Gv/Gp were suitably controlled, the slopes “my” and “mz” of each soft magnetic alloy powder were within the predetermined ranges. The slopes “mY” and “mZ” of the magnetic core (toroidal core) produced using the soft magnetic alloy powder were within the predetermined ranges, and the DC superimposition characteristics were good.

In contrast, when W2/W1 was too small and when Gv/Gp was too large, the absolute value of the slope “mz” of the soft magnetic alloy powder was too large. Moreover, the slope “mZ” of the magnetic core (toroidal core) produced using the soft magnetic alloy powder fell outside the predetermined range, and the DC superimposition characteristics were reduced.

When W2/W1 was too large and when Gv/Gp was too small, the absolute value of the slope “my” of the soft magnetic alloy powder was too large. Moreover, the slope “mY” of the magnetic core (toroidal core) produced using the soft magnetic alloy powder fell outside the predetermined range, and the DC superimposition characteristics were reduced.

### Experiment 5

Using the soft magnetic alloy powders of Sample Nos. 1, 7, and 11 of Experiment 1, magnetic cores having different relative permeability (μ) were produced at different molding pressures. As in Experiment 1, the average particle size D2, the average circularity C2, the slopes “mY” and “mZ”, μ, and μHdc of each magnetic core were measured. The increase rate of from μHdc of the magnetic core produced using the soft magnetic alloy powder of Sample No. 1 to μHdc of the magnetic core produced using the soft magnetic alloy powder of Sample No. 7 or Sample No. 11 was calculated in the cases in which the relative permeability (μ) was the same between the two magnetic cores. Table 22 shows the results.

TABLE 22

| | | | | Soft magnetic alloy powder | | | | Magnetic core | | | | | |
|---|---|---|---|---|---|---|---|---|---|---|---|---|---|
| | | | | | Average | | | | Average | | | | |
| | | Powder manufacturing | | Average | circu- | | | Average | circu- | | | | μHdc |
| | | conditions | | particle | larity | | | particle | larity | | | | increase |
| Sample | Example/ | W2/W1 | Gv/Gp | size D1 | C1 | my | mz | size D2 | C2 | mY | mZ | μ | rate |
| No. | Comparative Example | (—) | (m³/MPa) | (μm) | (—) | (—) | (—) | (μm) | (—) | (—) | (—) | (—) | (—) |
| 279 | Comparative Example | 1.00 | 5 | 7.81 | 0.97 | −0.0014 | 0.00070 | 7.24 | 0.89 | −0.0015 | 0.00069 | 25 | 1.00 |
| 280 | Example | 1.20 | 5 | 7.92 | 0.96 | −0.0014 | 0.00020 | 7.32 | 0.86 | −0.0015 | 0.00021 | 25 | 2.75 |
| 281 | Comparative Example | 3.50 | 5 | 7.92 | 0.94 | −0.0032 | 0.00010 | 7.33 | 0.83 | −0.0033 | 0.00011 | 25 | 1.14 |
| 1 | Comparative Example | 1.00 | 5 | 7.81 | 0.97 | −0.0014 | 0.00070 | 7.18 | 0.87 | −0.0015 | 0.00068 | 30 | 1.00 |
| 7 | Example | 1.20 | 5 | 7.92 | 0.96 | −0.0014 | 0.00020 | 7.29 | 0.85 | −0.0015 | 0.00021 | 30 | 2.81 |
| 11 | Comparative Example | 3.50 | 5 | 7.92 | 0.94 | −0.0032 | 0.00010 | 7.29 | 0.82 | −0.0034 | 0.00010 | 30 | 1.23 |
| 282 | Comparative Example | 1.00 | 5 | 7.81 | 0.97 | −0.0014 | 0.00070 | 7.10 | 0.86 | −0.0015 | 0.00069 | 35 | 1.00 |
| 283 | Example | 1.20 | 5 | 7.92 | 0.96 | −0.0014 | 0.00020 | 7.22 | 0.85 | −0.0015 | 0.00020 | 35 | 2.83 |
| 284 | Comparative Example | 3.50 | 5 | 7.92 | 0.94 | −0.0032 | 0.00010 | 7.23 | 0.82 | −0.0034 | 0.00010 | 35 | 1.22 |

Table 22 indicated that, even when u was changed, the results showed the same tendency as when μ=30 was satisfied.

### REFERENCE NUMERALS

10 . . . elliptical water flow atomizing apparatus
60 . . . molten metal supply unit
61 . . . molten metal
61a . . . molten metal drip
62 . . . container
63 . . . molten metal discharge port
64 . . . heating coil
66 . . . gas spray nozzle
67 . . . gas spray port
30 . . . cooling unit
32 . . . tubular body
33 . . . inner circumferential surface
34 . . . discharge port
36 . . . cooling liquid introduction unit
37 . . . supply line
52 . . . cooling liquid discharge port
50 . . . cooling liquid layer

What is claimed is:

1. A soft magnetic alloy powder comprising:
first particles including soft magnetic alloy particles having a particle size of D50 or less;
second particles including soft magnetic alloy particles having a particle size of more than D50 and D60 or less;
third particles including soft magnetic alloy particles having a particle size of more than D60 and D70 or less;
fourth particles including soft magnetic alloy particles having a particle size of more than D70 and D80 or less; and
fifth particles including soft magnetic alloy particles having a particle size of more than D80 and D90 or less,
wherein
nth particles among the first particles to the fifth particles have an average particle size xₙ (μm), an average circularity yₙ, and a variance zₙ of circularity, where nth is any ordinal number from first to fifth;
points (xₙ, yₙ) (n=1 to 5) plotted in an xy plane define an approximate straight line having a slope “my” of −0.0030 or more; and
points (xₙ, zₙ) (n=1 to 5) plotted in an xz plane define an approximate straight line having a slope “mz” of 0.00050 or less.

2. A magnetic core comprising:
first particles including soft magnetic alloy particles having a particle size of D50 or less;
second particles including soft magnetic alloy particles having a particle size of more than D50 and D60 or less;
third particles including soft magnetic alloy particles having a particle size of more than D60 and D70 or less;
fourth particles including soft magnetic alloy particles having a particle size of more than D70 and D80 or less; and
fifth particles including soft magnetic alloy particles having a particle size of more than D80 and D90 or less,
wherein
nth particles among the first particles to the fifth particles have an average particle size Xₙ (μm), an average circularity Yₙ, and a variance Zₙ of circularity, where nth is any ordinal number from first to fifth;
points (Xₙ, Yₙ) (n=1 to 5) plotted in an XY plane define an approximate straight line having a slope “mY” of −0.0030 or more; and
points (Xₙ, Zₙ) (n=1 to 5) plotted in an XZ plane define an approximate straight line having a slope “mZ” of 0.00050 or less.

3. The magnetic core according to claim 2 further comprising a resin.

4. A magnetic component comprising the magnetic core according to claim 2.

5. An electronic device comprising the magnetic core according to claim 2.
